(19) United States
(12) Patent Application Publication
(10) Pub. No.: US 2024/0333638 A1
(43) Pub. Date: Oct. 3, 2024

(54) UNIDIRECTIONAL COMMUNICATION OF DATA VIA A DATA DIODE BETWEEN DISTINCT NETWORKS

(71) Applicant: HONEYWELL INTERNATIONAL INC., CHARLOTTE, NC (US)

(72) Inventors: Tarun Gupta, Bangalore (IN); Atul Bassi, Bangalore (IN); Anubhav Misra, Bangalore (IN)

(21) Appl. No.: 18/194,297

(22) Filed: Mar. 31, 2023

(51) Int. Cl. H04L 45/00; H04L 41/122; H04L 45/745

(52) U.S. Cl. CPC H04L 45/38; H04L 41/122; H04L 45/745

(57) ABSTRACT

Various embodiments described herein relate to providing unidirectional communication of data via a data diode between distinct networks. In an embodiment, an operational technology (OT) data packet associated with one or more asset devices connected to a first network with a first classification is received. Additionally, one or more attributes of the OT data packet are compared to a set of flow rules associated with a flow table for a network switch of the first network. Based at least in part on whether a match is identified between the one or more attributes of the OT data packet and at least one flow rule of the set of flow rules, the OT data packet is transmitted to a second network associated with a second classification.

### TECHNICAL FIELD

The present disclosure relates generally to network communications, and more particularly to unidirectional communication of data between distinct networks.

### BACKGROUND

An industrial network (e.g., an industrial network associated with industrial automation and control systems) often includes thousands of assets such as, for example, sensors, input/output modules, controllers, firewall devices, supervisory nodes, application nodes, and/or other assets. Furthermore, different assets in an industrial network often include different sets of software and/or different sets of hardware connected to the same network or a different network via switches, routers, firewall devices, etc. As such, there are numerous technical challenges related to network communications for an industrial network.

### SUMMARY

The details of some embodiments of the subject matter described in this specification are set forth in the accompanying drawings and the description below. Other features, aspects, and advantages of the subject matter will become apparent from the description, the drawings, and the claims.

In an embodiment, a system comprises one or more processors and a memory having program code stored thereon. The program code, in execution with the at least one processor, causes the system to receive an operational technology (OT) data packet associated with one or more asset devices connected to a first network with a first classification. In one or more embodiments, the program code, in execution with the at least one processor, also causes the system to compare one or more attributes of the OT data packet to a set of flow rules associated with a flow table for a network switch of the first network. In one or more embodiments, the program code, in execution with the at least one processor, also causes the system to transmit the OT data packet to a second network associated with a second classification based at least in part on whether a match is identified between the one or more attributes of the OT data packet and at least one flow rule of the set of flow rules.

In another embodiment, a computer-implemented method is provided. The computer-implemented method provides for receiving an OT data packet associated with one or more asset devices connected to a first network with a first classification. In one or more embodiments, the computer-implemented method also provides for comparing one or more attributes of the OT data packet to a set of flow rules associated with a flow table for a network switch of the first network. In one or more embodiments, the computer-implemented method also provides for transmitting the OT data packet to a second network associated with a second classification based at least in part on whether a match is identified between the one or more attributes of the OT data packet and at least one flow rule of the set of flow rules.

In yet another embodiment, a computer program product comprises at least one non-transitory computer-readable storage medium having computer-readable program code portions stored therein. The computer-readable program code portions comprise an executable portion configured to receive an OT data packet associated with one or more asset devices connected to a first network with a first classification. In one or more embodiments, the computer-readable program code portions also comprise an executable portion configured to compare one or more attributes of the OT data packet to a set of flow rules associated with a flow table for a network switch of the first network. In one or more embodiments, the computer-readable program code portions also comprise an executable portion configured to transmit the OT data packet to a second network associated with a second classification based at least in part on whether a match is identified between the one or more attributes of the OT data packet and at least one flow rule of the set of flow rules.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 illustrates an exemplary networked computing system environment, in accordance with one or more embodiments described herein;

FIG. 2 illustrates a schematic block diagram of a framework of an IoT platform of the networked computing system, in accordance with one or more embodiments described herein;

FIG. 3 illustrates a system that provides an exemplary environment, in accordance with one or more embodiments described herein;

FIG. 4 illustrates an example operational technology (OT)/information technology (IT) network, in accordance with one or more embodiments described herein;

FIG. 5 illustrates an example visualization of operations performed for managing data packets for operational technology devices in a network, in accordance with one or more embodiments described herein;

FIG. 6 illustrates an example flow table, in accordance with one or more embodiments described herein;

FIG. 7 illustrates an example system related to a proactive data diode, in accordance with one or more embodiments described herein;

FIG. 8 illustrates another example flow table, in accordance with one or more embodiments described herein;

FIG. 9 illustrates an example system related to a reactive data diode, in accordance with one or more embodiments described herein;

FIG. 10 illustrates another example flow table, in accordance with one or more embodiments described herein;

FIG. 11 illustrates an example system related to an NFV data diode, in accordance with one or more embodiments described herein;

FIG. 12 illustrates a flow diagram for providing unidirectional communication of data via a data diode between distinct networks, in accordance with one or more embodiments described herein; and

FIG. 13 illustrates a functional block diagram of a computer that may be configured to execute techniques described in accordance with one or more embodiments described herein.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments. The term “or” is used herein in both the alternative and conjunctive sense, unless otherwise indicated. The terms “illustrative,” “example,” and “exemplary” are used to be examples with no indication of quality level. Like numbers refer to like elements throughout.

The phrases “in an embodiment,” “in one embodiment,” “according to one embodiment,” and the like generally mean that the particular feature, structure, or characteristic following the phrase can be included in at least one embodiment of the present disclosure, and can be included in more than one embodiment of the present disclosure (importantly, such phrases do not necessarily refer to the same embodiment).

The word “exemplary” is used herein to mean “serving as an example, instance, or illustration.” Any implementation described herein as “exemplary” is not necessarily to be construed as preferred or advantageous over other implementations.

If the specification states a component or feature “can,” “may,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature can be optionally included in some embodiments, or it can be excluded.

In general, the present disclosure provides for an “Internet-of-Things” or “IoT” platform for enterprise performance management that uses real-time accurate models and visual analytics to deliver intelligent actionable recommendations for sustained peak performance of an enterprise or organization. The IoT platform is an extensible platform that is portable for deployment in any cloud or data center environment for providing an enterprise-wide, top to bottom view, displaying the status of processes, assets, people, and safety. Further, the IoT platform of the present disclosure supports end-to-end capability to execute digital twins against process data and to translate the output into actionable insights, as detailed in the following description.

An industrial network (e.g., an industrial network associated with industrial automation and control systems) often includes thousands of assets such as, for example, sensors, input/output modules, controllers, firewall devices, supervisory nodes, application nodes, and/or other assets. Furthermore, different assets in an industrial network often include different sets of software and/or different sets of hardware connected to the same network or a different network via switches, routers, firewall devices, etc. As such, there are numerous technical challenges related to network communications for an industrial network.

As an example, an infrastructure of an industrial plant such as a process industry plant, a manufacturing plant, a chemical plant, an energy plant, petrochemical plant, an oil and gas refinery, a pharmaceutical plan, a food and beverage plant, a fertilizer plant, a power plant, or another type of industrial plant may be defined by an industrial network model (e.g., a Purdue network model) with a level 0, a level 1, a level 2, a level 3, a level 4, and/or a level 5 associated with an industrial network for an industrial plant. Levels 0-3 can comprise an industrial control system (ICS) with level 0 being the field level with field devices (e.g., sensors, actuators, etc.) and/or processing equipment that utilize an industrial network for communications. Level 4 and/or level 5 can correspond to “enterprise” level(s) of the industrial network for operations related to production scheduling and/or other enterprise operations for an industrial plant. The ICS can comprise a distributed control system (DCS) and/or a supervisory control and data acquisition (SCADA) system.

However, it is generally desirable to increase efficiency, reliability, flexibility, and/or security for an industrial network to enable processes, devices, user data and/or industrial data for continuous process optimization, industrial network performance opportunities, and/or other types of industrial network improvements. To enable to enable processes, devices, user data and/or industrial data for such industrial network improvements, additional connectivity to the Internet, additional sensors, additional wired networks, and/or additional wireless networks can be utilized to collect, analyze, and/or leverage data on-premise for an industrial plant and via the cloud. However, data-driven applications for industrial IoT often focus on productivity such as remote monitoring and/or supporting service technicians at an industrial plant. Additionally, in order to utilize relevant data associated with an industrial network, the data is generally transmitted on-premise for an industrial plant or off-site (e.g., via the cloud, mobile devices). Vertical networking is often employed for transmitting such data.

However, with vertical networking, cybersecurity threats for an industrial network can increase. In addition, with the increase in networking and data exchange via an operational level of an industrial network, an industrial plant and/or related connected assets can become increasingly vulnerable to cyber attacker. For example, an industrial plant is generally susceptible to a cyberattack via an industrial automation system and/or a control system of the industrial plant. An industrial automation system and/or a control system of an industrial plant is generally directly or indirectly connected to information technology networks such as a main control room for the industrial plant, a satellite rack room for the industrial plant, a plant network of the industrial plant, the Internet. As such, cyber attackers often exploit an industrial automation system and/or a control system of an industrial plant to take advantage of known and/or newly discovered infrastructure vulnerabilities of the industrial plant. Unlike computers and/or other computing devices implemented via an internet technology network, portions of an industrial automation system and/or a control system of an industrial plant generally include a distributed control system, process controllers, programmable logic controllers, supervisory control and data acquisition systems, computing stations (e.g., consoles, human-machine interfaces, etc.) and/or another type of system configured for process control functionalities with respect to the industrial plant. The portions of the industrial plant associated with process control functionalities is therefore generally susceptible to a cyberattack.

In another example, an industrial plant can include assets in different levels (e.g., different zones) such as, for example, assets (e.g., field instrument assets) in level 0 of an industrial network (e.g., zone 0 of the industrial plant), assets (e.g., embedded interface boards and controllers) in level 1 of an industrial network (e.g., zone 1 of the industrial plant), assets (e.g., supervisory nodes) in level 2 of an industrial network (e.g., zone 2 of the industrial plant), and assets (e.g., application nodes) in level 3 of an industrial network (e.g., zone 3 of the industrial plant). In yet another example, an industrial plant can include respective assets with respective software agents and/or data privileges that generally involve manual intervention (e.g., creating permission for installation of software, copying software, installing software in respective assets, etc.) to update potentially thousands of assets. In yet another example, an industrial plant can include third-party assets and/or controllers that include controller backplane assets. As such, the third-party assets may be vulnerable to a cyberattack due to unknown functionality with respect to the controllers.

Thus, to address these and/or other issues, unidirectional communication of data via a data diode between distinct networks is provided. The data diode can be configured as a unidirectional gateway between the distinct networks. In one or more embodiments, the distinct networks can correspond to an operational technology (OT) network and an information technology (IT) network. In various embodiments, Defined Networking (SDN) and Network Function Virtualization (NFV) are utilized to implement a data diode between distinct networks for unidirectional communication. The data diode can provide cost-effective communication between the distinct networks. By employing the data diode, data can flow exclusively in a predefined direction (e.g., a single predefined direction) associated with unidirectional communication. For example, with the data diode, data associated with the predefined direction can flow from a first network identified as a secured critical network to a second network identified as a less secure open network. In various embodiments, the data diode can restrict data communication via a reverse data flow with respect to the predefined direction. Accordingly, complete protection and/or isolation of distinct networks for an industrial network can be provided. Additionally, cybersecurity and/or firewall vulnerabilities for an industrial network can be overcome.

In various embodiments, the unidirectional communication of data via the data diode can enable secure data transfer to enterprise networks or the Internet for cloud-based applications and/or services without compromising security of critical networks. In such implementations, a defined network segregation between distinct networks (e.g., an OT network and an IT network) can be provided, thereby minimizing operational disruptions of an industrial network and/or enabling a secure on-premises edge environment that restricts attempts to send data to the OT network. In various embodiments, the unidirectional communication of data via the data diode can be implemented between level 3 and level 4 of an industrial network. For example, the unidirectional communication of data via the data diode can be implemented via an L3.5 network.

In various embodiments, the SDN can shift network equipment control plane functionality to a logically centralized entity such as, for example, a network controller. For example, with SDN, intelligence of network switches can be modified (e.g., decreased to “dumb” devices). Additionally, forwarding tables of the network switches can be updated by the network controller using a communication protocol such as, for example, OpenFlow. The NFV can decouple network equipment functionality via multiple Virtual Network Functions (VNFs) arranged in a chain configuration, which may be hosted in dispersed infrastructure points-of-presence.

With the SDN, the network controller can be enabled with a global view of a network topology graph of the industrial network. The network controller can also be enabled with real-time state awareness of allowed network flows and/or can modify network state via a proactive rules (e.g., pre-initializing flow rules, etc.) and/or reactive rules (e.g., deciding upon packet arrival, etc.). Accordingly, in various embodiments, the data diode can be configured as an SDN-based data diode to provide an alternative to traditional firewalls and/or traditional security protocols. In various embodiments, to efficiently forward network packets, the network switches can contain forwarding tables (e.g., ternary content-addressable memory (TCAM)) configured to perform an entire table lookup in one clock cycle. As such, an SDN-enabled data diode can be configured to effectively block traffic at layer 2 of an industrial network, thereby mitigating traditional latency imposed by firewall middleboxes.

In various embodiments, the data diode can be configured as a single managing interface to control communications in an industrial network and/or to mitigate placement restrictions imposed by traditional hardware configurations for an industrial network. For example, the communication protocol can be a layer 3 network protocol that provides access to a forwarding plane of a network switch over the industrial network. The communication protocol can additionally or alternatively enable network controllers to determine a path of network packets across the switch fabric. In various embodiments, the communication protocol can be implemented on top of a TCP/IP portion of an industrial network.

In various embodiments, communication between a network controller and a network switch can be configured via a transport layer security (TLS) protocol of the industrial network. The TLS protocol can be executed in a match-action manner such that when a data packet arrives at a switch port, the switch performs a table lookup in a flow table to match packet headers of the data packet against a set of flow rules installed in the switch. If a match is found, the switch can apply an instruction set configured in the flow rule. However, in a scenario where a table miss occurs, the corresponding packet action can depend on the table configuration. For example, the data packet can be forwarded to the controller for further processing (e.g., using packet-in messages), the data packet can be moved further on the flow table pipeline, the data packet can have header fields re-written, or the data packet can be dropped. The match fields in a flow table include fields ranging from layer 1 to layer 4 for providing fine-grained control over identification of the data packet and/or a destination of the data packet.

Moreover, with the unidirectional communication of data via a data diode disclosed herein, performance of a network (e.g., an industrial network) and/or assets within a network are improved. For instance, by employing one or more techniques disclosed herein, network performance, asset performance and/or process performance is optimized. Additionally, performance of a processing system associated with management of transmission of communication of data and/or management of a data diode is improved by employing one or more techniques disclosed herein. For example, a number of computing resources, a number of a storage requirements, and/or number of errors associated with management of transmission of communication of data and/or management of a data diode is reduced by employing one or more techniques disclosed herein.

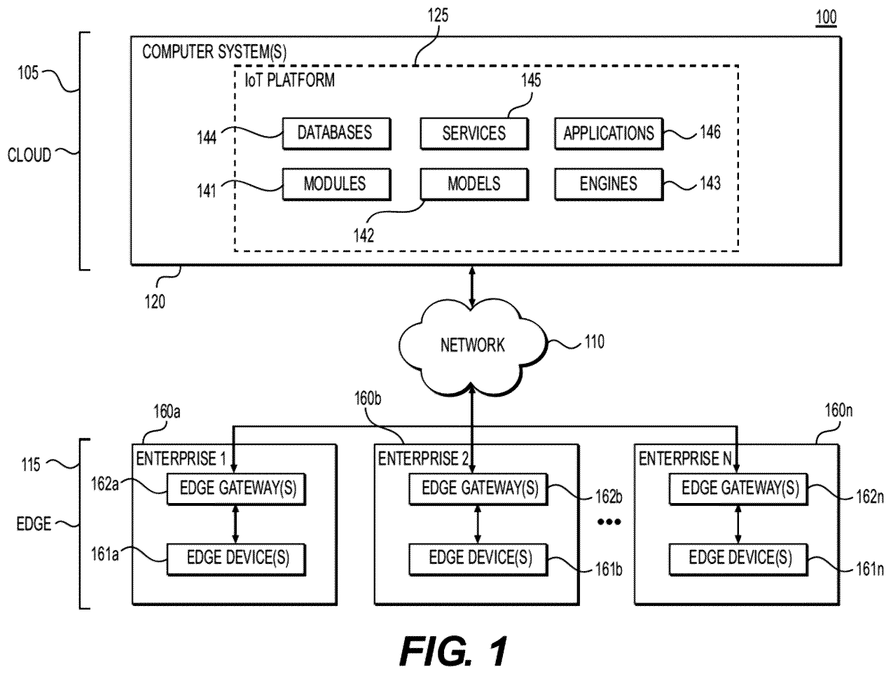

FIG. 1 illustrates an exemplary networked computing system environment 100, according to the present disclosure. As shown in FIG. 1, networked computing system environment 100 is organized into a plurality of layers including a cloud 105 (e.g., cloud layer), a network 110 (e.g., a network layer), and an edge 115 (e.g., edge layer). As detailed further below, components of the edge 115 are in communication with components of the cloud 105 via network 110.

In various embodiments, network 110 is any suitable network or combination of networks and supports any appropriate protocol suitable for communication of data to and from components of the cloud 105 and between various other components in the networked computing system environment 100 (e.g., components of the edge 115). According to various embodiments, network 110 includes a public network (e.g., the Internet), a private network (e.g., a network within an organization), or a combination of public and/or private networks. According to various embodiments, network 110 is configured to provide communication between various components depicted in FIG. 1. According to various embodiments, network 110 comprises one or more networks that connect devices and/or components in the network layout to allow communication between the devices and/or components. For example, in one or more embodiments, the network 110 is implemented as the Internet, a wireless network, a wired network (e.g., Ethernet), a local area network (LAN), a Wide Area Network (WANs), Bluetooth, Near Field Communication (NFC), or any other type of network that provides communications between one or more components of the network layout. In some embodiments, network 110 is implemented using cellular networks, satellite, licensed radio, or a combination of cellular, satellite, licensed radio, and/or unlicensed radio networks.

Components of the cloud 105 include one or more computer systems 120 that form a so-called “Internet-of-Things” or “IoT” platform 125. It should be appreciated that “IoT platform” is an optional term describing a platform connecting any type of Internet-connected device, and should not be construed as limiting on the types of computing systems useable within IoT platform 125. In particular, in various embodiments, computer systems 120 includes any type or quantity of one or more processors and one or more data storage devices comprising memory for storing and executing applications or software modules of networked computing system environment 100. In one embodiment, the processors and data storage devices are embodied in server-class hardware, such as enterprise-level servers. For example, in an embodiment, the processors and data storage devices comprise any type or combination of application servers, communication servers, web servers, super-computing servers, database servers, file servers, mail servers, proxy servers, and/virtual servers. Further, the one or more processors are configured to access the memory and execute processor-readable instructions, which when executed by the processors configures the processors to perform a plurality of functions of the networked computing system environment 100.

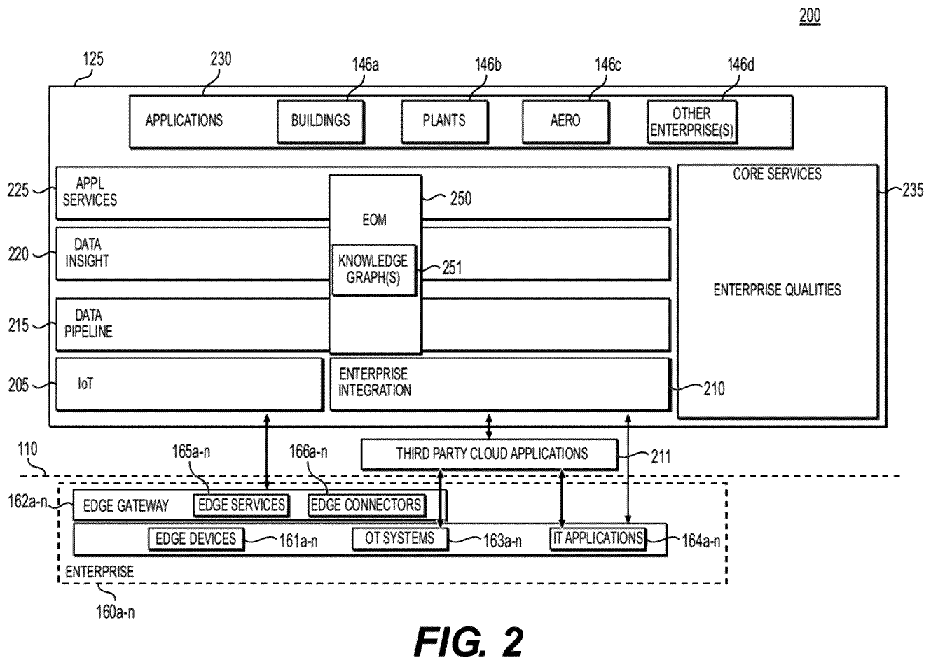

Computer systems 120 further include one or more software components of the IoT platform 125. For example, in one or more embodiments, the software components of computer systems 120 include one or more software modules to communicate with user devices and/or other computing devices through network 110. For example, in one or more embodiments, the software components include one or more modules 141, models 142, engines 143, databases 144, services 145, and/or applications 146, which may be stored in/by the computer systems 120 (e.g., stored on the memory), as detailed with respect to FIG. 2 below. According to various embodiments, the one or more processors are configured to utilize the one or more modules 141, models 142, engines 143, databases 144, services 145, and/or applications 146 when performing various methods described in this disclosure.

Accordingly, in one or more embodiments, computer systems 120 execute a cloud computing platform (e.g., IoT platform 125) with scalable resources for computation and/or data storage, and may run one or more applications on the cloud computing platform to perform various computer-implemented methods described in this disclosure. In some embodiments, some of the modules 141, models 142, engines 143, databases 144, services 145, and/or applications 146 are combined to form fewer modules, models, engines, databases, services, and/or applications. In some embodiments, some of the modules 141, models 142, engines 143, databases 144, services 145, and/or applications 146 are separated into separate, more numerous modules, models, engines, databases, services, and/or applications. In some embodiments, some of the modules 141, models 142, engines 143, databases 144, services 145, and/or applications 146 are removed while others are added.

The computer systems 120 are configured to receive data from other components (e.g., components of the edge 115) of networked computing system environment 100 via network 110. Computer systems 120 are further configured to utilize the received data to produce a result. According to various embodiments, information indicating the result is transmitted to users via user computing devices over network 110. In some embodiments, the computer systems 120 is a server system that provides one or more services including providing the information indicating the received data and/or the result(s) to the users. According to various embodiments, computer systems 120 are part of an entity which include any type of company, organization, or institution that implements one or more IoT services. In some examples, the entity is an IoT platform provider.

Components of the edge 115 include one or more enterprises 160a-160n each including one or more edge devices 161a-161n and one or more edge gateways 162a-162n. For example, a first enterprise 160a includes first edge devices 161a and first edge gateways 162a, a second enterprise 160b includes second edge devices 161b and second edge gateways 162b, and an nth enterprise 160n includes nth edge devices 161n and nth edge gateways 162n. As used herein, enterprises 160a-160n represent any type of entity, facility, or vehicle, such as, for example, companies, divisions, buildings, manufacturing plants, warehouses, real estate facilities, laboratories, aircraft, spacecraft, automobiles, ships, boats, military vehicles, oil and gas facilities, or any other type of entity, facility, and/or entity that includes any number of local devices.

According to various embodiments, the edge devices 161a-161n represent any of a variety of different types of devices that may be found within the enterprises 160a-160n. Edge devices 161a-161n are any type of device configured to access network 110, or be accessed by other devices through network 110, such as via an edge gateway 162a-162n. According to various embodiments, edge devices 161a-161n are “IoT devices” which include any type of network-connected (e.g., Internet-connected) device. For example, in one or more embodiments, the edge devices 161a-161n include assets, sensors, actuators, processors, computers, valves, pumps, ducts, vehicle components, cameras, displays, doors, windows, security components, boilers, chillers, pumps, HVAC components, factory equipment, and/or any other devices that are connected to the network 110 for collecting, sending, and/or receiving information. Each edge device 161a-161n includes, or is otherwise in communication with, one or more controllers for selectively controlling a respective edge device 161a-161n and/or for sending/receiving information between the edge devices 161a-161n and the cloud 105 via network 110. With reference to FIG. 2, in one or more embodiments, the edge 115 include OT systems 163a-163n and IT applications 164a-164n of each enterprise 160a-161n. The OT systems 163a-163n include hardware and software for detecting and/or causing a change, through the direct monitoring and/or control of industrial equipment (e.g., edge devices 161a-161n), assets, processes, and/or events. The IT applications 164a-164n includes network, storage, and computing resources for the generation, management, storage, and delivery of data throughout and between organizations.

The edge gateways 162a-162n include devices for facilitating communication between the edge devices 161a-161n and the cloud 105 via network 110. For example, the edge gateways 162a-162n include one or more communication interfaces for communicating with the edge devices 161a-161n and for communicating with the cloud 105 via network 110. According to various embodiments, the communication interfaces of the edge gateways 162a-162n include one or more cellular radios, Bluetooth, WiFi, near-field communication radios, Ethernet, or other appropriate communication devices for transmitting and receiving information. According to various embodiments, multiple communication interfaces are included in each gateway 162a-162n for providing multiple forms of communication between the edge devices 161a-161n, the gateways 162a-162n, and the cloud 105 via network 110. For example, in one or more embodiments, communication are achieved with the edge devices 161a-161n and/or the network 110 through wireless communication (e.g., WiFi, radio communication, etc.) and/or a wired data connection (e.g., a universal serial bus, an onboard diagnostic system, etc.) or other communication modes, such as a local area network (LAN), wide area network (WAN) such as the Internet, a telecommunications network, a data network, or any other type of network.

According to various embodiments, the edge gateways 162a-162n also include a processor and memory for storing and executing program instructions to facilitate data processing. For example, in one or more embodiments, the edge gateways 162a-162n are configured to receive data from the edge devices 161a-161n and process the data prior to sending the data to the cloud 105. Accordingly, in one or more embodiments, the edge gateways 162a-162n include one or more software modules or components for providing data processing services and/or other services or methods of the present disclosure. With reference to FIG. 2, each edge gateway 162a-162n includes edge services 165a-165n and edge connectors 166a-166n. According to various embodiments, the edge services 165a-165n include hardware and software components for processing the data from the edge devices 161a-161n. According to various embodiments, the edge connectors 166a-166n include hardware and software components for facilitating communication between the edge gateway 162a-162n and the cloud 105 via network 110, as detailed above. In some cases, any of edge devices 161a-n, edge connectors 166a-n, and edge gateways 162a-n have their functionality combined, omitted, or separated into any combination of devices. In other words, an edge device and its connector and gateway need not necessarily be discrete devices.

FIG. 2 illustrates a schematic block diagram of framework 200 of the IoT platform 125, according to the present disclosure. The IoT platform 125 of the present disclosure is a platform for enterprise performance management that uses real-time accurate models and visual analytics to deliver intelligent actionable recommendations and/or analytics for sustained peak performance of the enterprise 160a-160n. The IoT platform 125 is an extensible platform that is portable for deployment in any cloud or data center environment for providing an enterprise-wide, top to bottom view, displaying the status of processes, assets, people, and safety. Further, the IoT platform 125 supports end-to-end capability to execute digital twins against process data and to translate the output into actionable insights, using the framework 200, detailed further below.

As shown in FIG. 2, the framework 200 of the IoT platform 125 comprises a number of layers including, for example, an IoT layer 205, an enterprise integration layer 210, a data pipeline layer 215, a data insight layer 220, an application services layer 225, and an applications layer 230. The IoT platform 125 also includes a core services layer 235 and an extensible object model (EOM) 250 comprising one or more knowledge graphs 251. The layers 205-235 further include various software components that together form each layer 205-235. For example, in one or more embodiments, each layer 205-235 includes one or more of the modules 141, models 142, engines 143, databases 144, services 145, applications 146, or combinations thereof. In some embodiments, the layers 205-235 are combined to form fewer layers. In some embodiments, some of the layers 205-235 are separated into separate, more numerous layers. In some embodiments, some of the layers 205-235 are removed while others may be added.

The IoT platform 125 is a model-driven architecture. Thus, the extensible object model 250 communicates with each layer 205-230 to contextualize site data of the enterprise 160a-160n using an extensible graph-based object model (or “asset model”). In one or more embodiments, the extensible object model 250 is associated with knowledge graphs 251 where the equipment (e.g., edge devices 161a-161n) and processes of the enterprise 160a-160n are modeled. The knowledge graphs 251 of EOM 250 are configured to store the models in a central location. The knowledge graphs 251 define a collection of nodes and links that describe real-world connections that enable smart systems. As used herein, a knowledge graph 251: (i) describes real-world entities (e.g., edge devices 161a-161n) and their interrelations organized in a graphical interface; (ii) defines possible classes and relations of entities in a schema; (iii) enables interrelating arbitrary entities with each other; and (iv) covers various topical domains. In other words, the knowledge graphs 251 define large networks of entities (e.g., edge devices 161a-161n), semantic types of the entities, properties of the entities, and relationships between the entities. Thus, the knowledge graphs 251 describe a network of “things” that are relevant to a specific domain or to an enterprise or organization. Knowledge graphs 251 are not limited to abstract concepts and relations, but can also contain instances of objects, such as, for example, documents and datasets. In some embodiments, the knowledge graphs 251 include resource description framework (RDF) graphs. As used herein, a “RDF graph” is a graph data model that formally describes the semantics, or meaning, of information. The RDF graph also represents metadata (e.g., data that describes data). According to various embodiments, knowledge graphs 251 also include a semantic object model. The semantic object model is a subset of a knowledge graph 251 that defines semantics for the knowledge graph 251. For example, the semantic object model defines the schema for the knowledge graph 251.

As used herein, EOM 250 includes a collection of application programming interfaces (APIs) that enables seeded semantic object models to be extended. For example, the EOM 250 of the present disclosure enables a customer's knowledge graph 251 to be built subject to constraints expressed in the customer's semantic object model. Thus, the knowledge graphs 251 are generated by customers (e.g., enterprises or organizations) to create models of the edge devices 161a-161n of an enterprise 160a-160n, and the knowledge graphs 251 are input into the EOM 250 for visualizing the models (e.g., the nodes and links).

The models describe the assets (e.g., the nodes) of an enterprise (e.g., the edge devices 161a-161n) and describe the relationship of the assets with other components (e.g., the links). The models also describe the schema (e.g., describe what the data is), and therefore the models are self-validating. For example, in one or more embodiments, the model describes the type of sensors mounted on any given asset (e.g., edge device 161a-161n) and the type of data that is being sensed by each sensor. According to various embodiments, a KPI framework is used to bind properties of the assets in the extensible object model 250 to inputs of the KPI framework. Accordingly, the IoT platform 125 is an extensible, model-driven end-to-end stack including: two-way model sync and secure data exchange between the edge 115 and the cloud 105, metadata driven data processing (e.g., rules, calculations, and aggregations), and model driven visualizations and applications. As used herein, “extensible” refers to the ability to extend a data model to include new properties/columns/fields, new classes/tables, and new relations. Thus, the IoT platform 125 is extensible with regards to edge devices 161a-161n and the applications 146 that handle those devices 161a-161n. For example, when new edge devices 161a-161n are added to an enterprise 160a-160n system, the new devices 161a-161n will automatically appear in the IoT platform 125 so that the corresponding applications 146 understand and use the data from the new devices 161a-161n.

In some cases, asset templates are used to facilitate configuration of instances of edge devices 161a-161n in the model using common structures. An asset template defines the typical properties for the edge devices 161a-161n of a given enterprise 160a-160n for a certain type of device. For example, an asset template of a pump includes modeling the pump having inlet and outlet pressures, speed, flow, etc. The templates may also include hierarchical or derived types of edge devices 161a-161n to accommodate variations of a base type of device 161a-161n. For example, a reciprocating pump is a specialization of a base pump type and would include additional properties in the template. Instances of the edge device 161a-161n in the model are configured to match the actual, physical devices of the enterprise 160a-160n using the templates to define expected attributes of the device 161a-161n. Each attribute is configured either as a static value (e.g., capacity is 1000 BPH) or with a reference to a time series tag that provides the value. The knowledge graph 251 can automatically map the tag to the attribute based on naming conventions, parsing, and matching the tag and attribute descriptions and/or by comparing the behavior of the time series data with expected behavior. In one or more embodiments, each of the key attribute contributing to one or more metrics to drive a dashboard is marked with one or more metric tags such that a dashboard visualization is generated.

The modeling phase includes an onboarding process for syncing the models between the edge 115 and the cloud 105. For example, in one or more embodiments, the onboarding process includes a simple onboarding process, a complex onboarding process, and/or a standardized rollout process. The simple onboarding process includes the knowledge graph 251 receiving raw model data from the edge 115 and running context discovery algorithms to generate the model. The context discovery algorithms read the context of the edge naming conventions of the edge devices 161a-161n and determine what the naming conventions refer to. For example, in one or more embodiments, the knowledge graph 251 receives “TMP” during the modeling phase and determine that “TMP” relates to “temperature.” The generated models are then published. The complex onboarding process includes the knowledge graph 251 receiving the raw model data, receiving point history data, and receiving site survey data. According to various embodiments, the knowledge graph 251 then uses these inputs to run the context discovery algorithms. According to various embodiments, the generated models are edited and then the models are published. The standardized rollout process includes manually defining standard models in the cloud 105 and pushing the models to the edge 115.

The IoT layer 205 includes one or more components for device management, data ingest, and/or command/control of the edge devices 161a-161n. The components of the IoT layer 205 enable data to be ingested into, or otherwise received at, the IoT platform 125 from a variety of sources. For example, in one or more embodiments, data is ingested from the edge devices 161a-161n through process historians or laboratory information management systems. The IoT layer 205 is in communication with the edge services 165a-165n installed on the edge gateways 162a-162n through network 110, and the edge services 165a-165n send the data securely to the IoT platform 205. In some embodiments, only authorized data is sent to the IoT platform 125, and the IoT platform 125 only accepts data from authorized edge gateways 162a-162n and/or edge devices 161a-161n. According to various embodiments, data is sent from the edge gateways 162a-162n to the IoT platform 125 via direct streaming and/or via batch delivery. Further, after any network or system outage, data transfer will resume once communication is re-established and any data missed during the outage will be backfilled from the source system or from a cache of the IoT platform 125. According to various embodiments, the IoT layer 205 also includes components for accessing time series, alarms and events, and transactional data via a variety of protocols.

The enterprise integration layer 210 includes one or more components for events/messaging, file upload, and/or REST/OData. The components of the enterprise integration layer 210 enable the IoT platform 125 to communicate with third party cloud applications 211, such as any application(s) operated by an enterprise in relation to its edge devices. For example, the enterprise integration layer 210 connects with enterprise databases, such as guest databases, customer databases, financial databases, patient databases, etc. The enterprise integration layer 210 provides a standard application programming interface (API) to third parties for accessing the IoT platform 125. The enterprise integration layer 210 also enables the IoT platform 125 to communicate with the OT systems 163a-163n and IT applications 164a-164n of the enterprise 160a-160n. Thus, the enterprise integration layer 210 enables the IoT platform 125 to receive data from the third-party cloud applications 211 rather than, or in combination with, receiving the data from the edge devices 161a-161n directly.

The data pipeline layer 215 includes one or more components for data cleansing/enriching, data transformation, data calculations/aggregations, and/or API for data streams. Accordingly, in one or more embodiments, the data pipeline layer 215 pre-processes and/or performs initial analytics on the received data. The data pipeline layer 215 executes advanced data cleansing routines including, for example, data correction, mass balance reconciliation, data conditioning, component balancing and simulation to ensure the desired information is used as a basis for further processing. The data pipeline layer 215 also provides advanced and fast computation. For example, cleansed data is run through enterprise-specific digital twins. According to various embodiments, the enterprise-specific digital twins include a reliability advisor containing process models to determine the current operation and the fault models to trigger any early detection and determine an appropriate resolution. According to various embodiments, the digital twins also include an optimization advisor that integrates real-time economic data with real-time process data, selects the right feed for a process, and determines optimal process conditions and product yields.

According to various embodiments, the data pipeline layer 215 employs models and templates to define calculations and analytics. Additionally or alternatively, according to various embodiments, the data pipeline layer 215 employs models and templates to define how the calculations and analytics relate to the assets (e.g., the edge devices 161a-161n). For example, in an embodiment, a pump template defines pump efficiency calculations such that every time a pump is configured, the standard efficiency calculation is automatically executed for the pump. The calculation model defines the various types of calculations, the type of engine that should run the calculations, the input and output parameters, the preprocessing requirement and prerequisites, the schedule, etc. According to various embodiments, the actual calculation or analytic logic is defined in the template or it may be referenced. Thus, according to various embodiments, the calculation model is employed to describe and control the execution of a variety of different process models. According to various embodiments, calculation templates are linked with the asset templates such that when an asset (e.g., edge device 161a-161n) instance is created, any associated calculation instances are also created with their input and output parameters linked to the appropriate attributes of the asset (e.g., edge device 161a-161n).

According to various embodiments, the IoT platform 125 supports a variety of different analytics models including, for example, first principles models, empirical models, engineered models, user-defined models, machine learning models, built-in functions, and/or any other types of analytics models. Fault models and predictive maintenance models will now be described by way of example, but any type of models may be applicable.

Fault models are used to compare current and predicted enterprise 160a-160n performance to identify issues or opportunities, and the potential causes or drivers of the issues or opportunities. The IoT platform 125 includes rich hierarchical symptom-fault models to identify abnormal conditions and their potential consequences. For example, in one or more embodiments, the IoT platform 125 drill downs from a high-level condition to understand the contributing factors, as well as determining the potential impact a lower level condition may have. There may be multiple fault models for a given enterprise 160a-160n looking at different aspects such as process, equipment, control, and/or operations. According to various embodiments, each fault model identifies issues and opportunities in their domain, and can also look at the same core problem from a different perspective. According to various embodiments, an overall fault model is layered on top to synthesize the different perspectives from each fault model into an overall assessment of the situation and point to the true root cause.

According to various embodiments, when a fault or opportunity is identified, the IoT platform 125 provides recommendations about an optimal corrective action to take. Initially, the recommendations are based on expert knowledge that has been pre-programmed into the system by process and equipment experts. A recommendation services module presents this information in a consistent way regardless of source, and supports workflows to track, close out, and document the recommendation follow-up. According to various embodiments, the recommendation follow-up is employed to improve the overall knowledge of the system over time as existing recommendations are validated (or not) or new cause and effect relationships are learned by users and/or analytics.

According to various embodiments, the models are used to accurately predict what will occur before it occurs and interpret the status of the installed base. Thus, the IoT platform 125 enables operators to quickly initiate maintenance measures when irregularities occur. According to various embodiments, the digital twin architecture of the IoT platform 125 employs a variety of modeling techniques. According to various embodiments, the modeling techniques include, for example, rigorous models, fault detection and diagnostics (FDD), descriptive models, predictive maintenance, prescriptive maintenance, process optimization, and/or any other modeling technique.

According to various embodiments, the rigorous models are converted from process design simulation. In this manner, process design is integrated with feed conditions and production requirement. Process changes and technology improvement provide business opportunities that enable more effective maintenance schedule and deployment of resources in the context of production needs. The fault detection and diagnostics include generalized rule sets that are specified based on industry experience and domain knowledge and can be easily incorporated and used working together with equipment models. According to various embodiments, the descriptive models identifies a problem and the predictive models determines possible damage levels and maintenance options. According to various embodiments, the descriptive models include models for defining the operating windows for the edge devices 161a-161n.

Predictive maintenance includes predictive analytics models developed based on rigorous models and statistic models, such as, for example, principal component analysis (PCA) and partial least square (PLS). According to various embodiments, machine learning methods are applied to train models for fault prediction. According to various embodiments, predictive maintenance leverages FDD-based algorithms to continuously monitor individual control and equipment performance. Predictive modeling is then applied to a selected condition indicator that deteriorates in time. Prescriptive maintenance includes determining an optimal maintenance option and when it should be performed based on actual conditions rather than time-based maintenance schedule. According to various embodiments, prescriptive analysis selects the right solution based on the company's capital, operational, and/or other requirements. Process optimization is determining optimal conditions via adjusting set-points and schedules. The optimized set-points and schedules can be communicated directly to the underlying controllers, which enables automated closing of the loop from analytics to control.

The data insight layer 220 includes one or more components for time series databases (TDSB), relational/document databases, data lakes, blob, files, images, and videos, and/or an API for data query. According to various embodiments, when raw data is received at the IoT platform 125, the raw data is stored as time series tags or events in warm storage (e.g., in a TSDB) to support interactive queries and to cold storage for archive purposes. According to various embodiments, data is sent to the data lakes for offline analytics development. According to various embodiments, the data pipeline layer 215 accesses the data stored in the databases of the data insight layer 220 to perform analytics, as detailed above.

The application services layer 225 includes one or more components for rules engines, workflow/notifications, KPI framework, insights (e.g., actionable insights), decisions, recommendations, machine learning, and/or an API for application services. The application services layer 225 enables building of applications 146a-d. The applications layer 230 includes one or more applications 146a-d of the IoT platform 125. For example, according to various embodiments, the applications 146a-d includes a buildings application 146a, a plants application 146b, an aero application 146c, and other enterprise applications 146d. According to various embodiments, the applications 146 includes general applications 146 for portfolio management, asset management, autonomous control, and/or any other custom applications. According to various embodiments, portfolio management includes the KPI framework and a flexible user interface (UI) builder. According to various embodiments, asset management includes asset performance and asset health. According to various embodiments, autonomous control includes energy optimization and/or predictive maintenance. As detailed above, according to various embodiments, the general applications 146 is extensible such that each application 146 is configurable for the different types of enterprises 160a-160n (e.g., buildings application 146a, plants application 146b, aero application 146c, and other enterprise applications 146d).

The applications layer 230 also enables visualization of performance of the enterprise 160a-160n. For example, dashboards provide a high-level overview with drill downs to support deeper investigations. Recommendation summaries give users prioritized actions to address current or potential issues and opportunities. Data analysis tools support ad hoc data exploration to assist in troubleshooting and process improvement.

The core services layer 235 includes one or more services of the IoT platform 125. According to various embodiments, the core services 235 include data visualization, data analytics tools, security, scaling, and monitoring. According to various embodiments, the core services 235 also include services for tenant provisioning, single login/common portal, self-service admin, UI library/UI tiles, identity/access/entitlements, logging/monitoring, usage metering, API gateway/dev portal, and the IoT platform 125 streams.

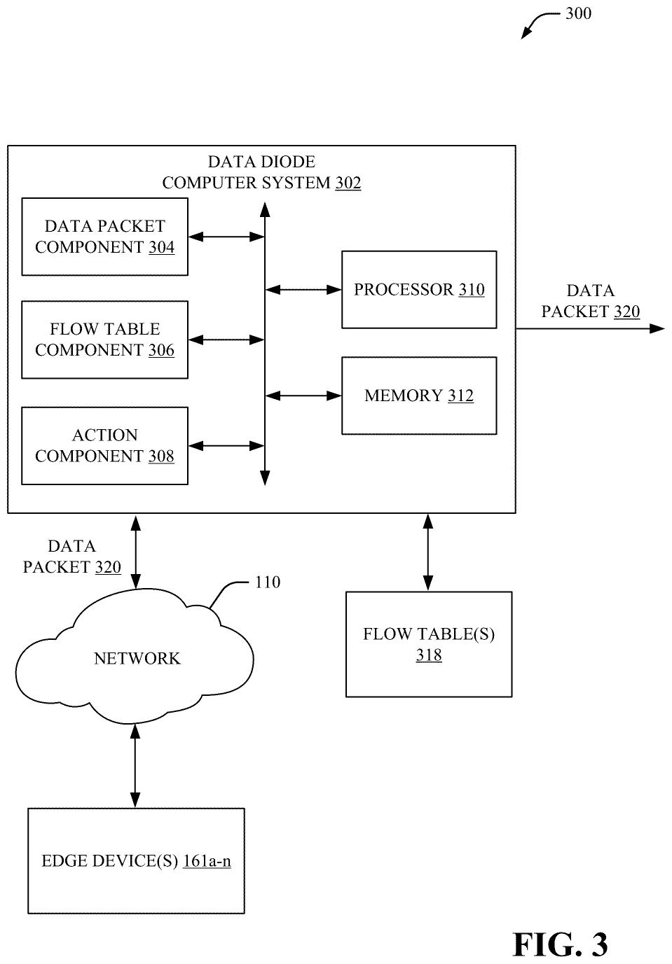

FIG. 3 illustrates a system 300 that provides an exemplary environment according to one or more described features of one or more embodiments of the disclosure. According to an embodiment, the system 300 includes a data diode computer system 302 to facilitate a practical application of unidirectional communication of data via a data diode between distinct networks.

In an embodiment, the data diode computer system 302 is a server system (e.g., a server device) that facilitates unidirectional communication of data via a data diode between distinct networks. Additionally or alternatively, the data diode computer system 302 can be implemented via level 3.5 of an industrial network to provide unidirectional communication of data via a data diode between distinct networks. Additionally or alternatively, the data diode computer system 302 can be implemented as and/or included in a data diode configured for SDN. In one or more embodiments, the data diode computer system 302 is a device with one or more processors and a memory. In one or more embodiments, the data diode computer system 302 is a computer system from the computer systems 120. For example, in one or more embodiments, the data diode computer system 302 is implemented via the cloud 105. The data diode computer system 302 is also related to one or more technologies, such as, for example, cybersecurity technologies, asset vulnerability technologies, industrial technologies, process plant technologies, oil and gas technologies, petrochemical technologies, refinery technologies, process plant technologies, supply chain analytics technologies, enterprise technologies, connected building technologies, industrial technologies, manufacturing technologies, Internet of Things (IoT) technologies, data analytics technologies, digital transformation technologies, cloud computing technologies, cloud database technologies, server technologies, network technologies, private enterprise network technologies, wireless communication technologies, machine learning technologies, artificial intelligence technologies, digital processing technologies, electronic device technologies, computer technologies, aircraft technologies, navigation technologies, asset visualization technologies, procurement technologies, and/or one or more other technologies.

Moreover, the data diode computer system 302 provides an improvement to one or more technologies such as cybersecurity technologies, asset vulnerability technologies, industrial technologies, process plant technologies, oil and gas technologies, petrochemical technologies, refinery technologies, process plant technologies, supply chain analytics technologies, enterprise technologies, connected building technologies, industrial technologies, manufacturing technologies, IoT technologies, data analytics technologies, digital transformation technologies, cloud computing technologies, cloud database technologies, server technologies, network technologies, private enterprise network technologies, wireless communication technologies, machine learning technologies, artificial intelligence technologies, digital processing technologies, electronic device technologies, computer technologies, aircraft technologies, navigation technologies, asset visualization technologies, procurement technologies, and/or one or more other technologies. In an implementation, the data diode computer system 302 improves performance of a computing device. For example, in one or more embodiments, the data diode computer system 302 improves processing efficiency of a computing device (e.g., a server), reduces power consumption of a computing device (e.g., a server), improves quality of data provided by a computing device (e.g., a server), etc. Additionally or alternatively, the data diode computer system 302 improves security of data communications related to a network (e.g., the network 110).

The data diode computer system 302 includes a data packet component 304, a flow table component 306 and/or an action component 308. Additionally, in one or more embodiments, the data diode computer system 302 includes a processor 310 and/or a memory 312. In certain embodiments, one or more aspects of the data diode computer system 302 (and/or other systems, apparatuses and/or processes disclosed herein) constitute executable instructions embodied within a computer-readable storage medium (e.g., the memory 312). For instance, in an embodiment, the memory 312 stores computer executable component and/or executable instructions (e.g., program instructions). Furthermore, the processor 310 facilitates execution of the computer executable components and/or the executable instructions (e.g., the program instructions). In an example embodiment, the processor 310 is configured to execute instructions stored in the memory 312 or otherwise accessible to the processor 310.

The processor 310 is a hardware entity (e.g., physically embodied in circuitry) capable of performing operations according to one or more embodiments of the disclosure. Alternatively, in an embodiment where the processor 310 is embodied as an executor of software instructions, the software instructions configure the processor 310 to perform one or more algorithms and/or operations described herein in response to the software instructions being executed. In an embodiment, the processor 310 is a single core processor, a multi-core processor, multiple processors internal to the data diode computer system 302, a remote processor (e.g., a processor implemented on a server), and/or a virtual machine. In certain embodiments, the processor 310 is in communication with the memory 312, the data packet component 304, the flow table component 306 and/or the action component 308 via a bus to, for example, facilitate transmission of data among the processor 310, the memory 312, the data packet component 304, the flow table component 306 and/or the action component 308. The processor 310 may be embodied in a number of different ways and, in certain embodiments, includes one or more processing devices configured to perform independently. Additionally or alternatively, in one or more embodiments, the processor 310 includes one or more processors configured in tandem via a bus to enable independent execution of instructions, pipelining of data, and/or multi-thread execution of instructions.

The memory 312 is non-transitory and includes, for example, one or more volatile memories and/or one or more non-volatile memories. In other words, in one or more embodiments, the memory 312 is an electronic storage device (e.g., a computer-readable storage medium). The memory 312 is configured to store information, data, content, one or more applications, one or more instructions, or the like, to enable the data diode computer system 302 to carry out various functions in accordance with one or more embodiments disclosed herein. As used herein in this disclosure, the term “component,” “system,” and the like, is a computer-related entity. For instance, “a component,” “a system,” and the like disclosed herein is either hardware, software, or a combination of hardware and software. As an example, a component is, but is not limited to, a process executed on a processor, a processor, circuitry, an executable component, a thread of instructions, a program, and/or a computer entity.

In an embodiment, the data diode computer system 302 (e.g., the data packet component 304 of the data diode computer system 302) receives a data packet 320 related to the edge devices 161a-161n. In one or more embodiments, the edge devices 161a-161n are associated with a portfolio of assets. For instance, in one or more embodiments, the edge devices 161a-161n include one or more assets in a portfolio of assets. The edge devices 161a-161n include, in one or more embodiments, one or more databases, one or more assets (e.g., one or more industrial assets, one or more building assets, etc.), one or more IoT devices (e.g., one or more industrial IoT devices), one or more connected building assets, one or more sensors, one or more actuators, one or more processors, one or more computers, one or more valves, one or more pumps (e.g., one or more centrifugal pumps, etc.), one or more motors, one or more compressors, one or more turbines, one or more ducts, one or more heaters, one or more chillers, one or more coolers, one or more storage tanks, one or more boilers, one or more furnaces, one or more heat exchangers, one or more fans, one or more blowers, one or more conveyor belts, one or more vehicle components, one or more cameras, one or more displays, one or more security components, one or more HVAC components, industrial equipment, factory equipment, refinery equipment, and/or one or more other devices that are connected to the network 110 for collecting, sending, and/or receiving information. In one or more embodiments, the edge device 161a-161n include, or is otherwise in communication with, one or more controllers for selectively controlling a respective edge device 161a-161n and/or for sending/receiving information between the edge devices 161a-161n and the data diode computer system 302 via the network 110.

In one or more embodiments, the data diode computer system 302 (e.g., the data packet component 304 of the data diode computer system 302) is in communication with the edge devices 161a-161n via the network 110. In one or more embodiments, the network 110 is a Wi-Fi network, a Near Field Communications (NFC) network, a Worldwide Interoperability for Microwave Access (WiMAX) network, a personal area network (PAN), a short-range wireless network (e.g., a Bluetooth® network), an infrared wireless (e.g., IrDA) network, an ultra-wideband (UWB) network, an induction wireless transmission network, and/or another type of network. In one or more embodiments, the edge devices 161a-161n are associated with an industrial environment (e.g., a plant, etc.). Additionally or alternatively, in one or more embodiments, the edge devices 161a-161n are associated with components of the edge 115 such as, for example, one or more enterprises 160a-160n.

In various embodiments, the edge devices 161a-161n can be included in and/or connected to a first network. The first network can be, for example, an OT network or another type of industrial network. In such implementations, the data packet 320 can be an OT data packet associated with the edge devices 161a-161n. Additionally or alternatively, the first network can be associated with a first classification. For example, the first network can be classified as a secured critical network of an industrial network.

In one or more embodiments, the data packet component 304 can determine one or more attributes associated with the data packet 320. The one or more attributes can include, for example, data packet header information for the data packet 320, a switch port identifier for a switch port associated with transmission of the data packet 320, an internet protocol (IP) address associated with the data packet 320, a media access control (MAC) address associated with the data packet 320, a network identifier associated with the data packet 320, a transmission control protocol (TCP) port associated with the data packet 320, a user datagram protocol (UDP) port associated with the data packet 320, a service associated with the data packet 320, metadata associated with the data packet 320, flow flags associated with the data packet 320, a port status (e.g., open state, closed state, etc.) associated with the data packet 320, an asset state associated with the data packet 320, an asset type associated with the data packet 320, and/or other attribute information associated with the data packet 320. In one or more embodiments, the one or more attributes are additionally or alternatively associated with one or more asset processes related to one or more edge devices from the edge devices 161a-161n. For example, in one or more embodiments, the one or more attributes additionally or alternatively includes data generated by one or more asset processes, data generated by one or more asset processes, and/or other data related to one or more asset processes.

The flow table component 306 can compare the one or more attributes of the data packet 320 to a set of flow rules associated with one or more flow tables 318. The one or more flow tables 318 can be respective flow tables for a network switch of the first network associated with the edge devices 161a-161n. The set of flow rules can include one or more proactive flow rules, one or more reactive flow rules, one or more NFV flow rules, and/or one or more other type of rules to manage transmission and/or modification of data packets.

The action component 308 can transmit the data packet 320 to a second network based at least in part on whether a match is identified between the one or more attributes of the data packet 320 and at least one flow rule of the set of flow rules. The second network can be, for example, an IT network or another type of industrial network. Additionally or alternatively, the second network can be associated with a second classification. For example, the second network can be classified as a less secure open network as compared to the first network.

In an embodiment, the action component 308 can apply an instruction set for the data packet 320 to cause transmission of the data packet 320 to the second network in response to a determination that the one or more attributes of the data packet 320 match at least one flow rule of the set of flow rules. The instruction set can be configured via the one or more flow tables 318. In certain embodiments, the action component 308 can transmit the data packet 320 via a defined switch port of the second network in response to a determination that the one or more attributes of the data packet 320 match at least one proactive flow rule of the set of flow rules. In certain embodiments, the action component 308 can forward the data packet 320 to a network controller of the first network in response to a determination that the one or more attributes of the data packet 320 match at least one reactive flow rule of the set of flow rules. In certain embodiments, the action component 308 can forward the data packet 320 to a virtual host of the second network in response to a determination that the one or more attributes of the data packet 320 match at least one NFV flow rule of the set of flow rules.

In another embodiment, the action component 308 can modify one or more portions of a data packet header of the data packet 320 in response to a determination that the one or more attributes of the data packet 320 do not match at least one flow rule of the set of flow rules. In certain embodiments, the action component 308 can withhold transmission of the data packet 320 (e.g., drop the data packet 320) in response to a determination that the one or more attributes of the data packet 320 do not match at least one flow rule of the set of flow rules. In certain embodiments, the action component 308 can decouple network equipment functionality between the first network and the second network in response to a determination that the one or more attributes of the data packet 320 do not match at least one flow rule of the set of flow rules.

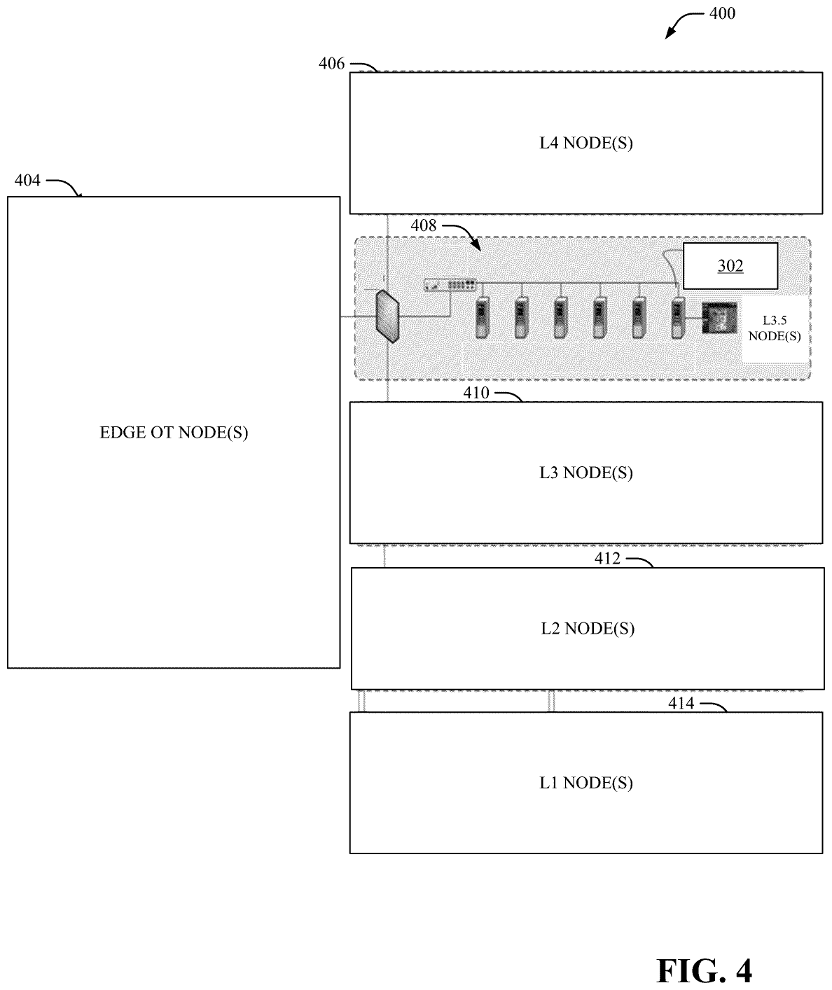

FIG. 4 illustrates a visualization of an example OT/IT network in accordance with one or more embodiments of the present disclosure. Specifically, FIG. 4 illustrates an example network 400. The network 400 can be, for example, an industrial network. In some embodiments, the network 400 includes a plurality of nodes, each facilitating communication to and/or between the various devices connected to the network 400. In this regard, each device connected to the network 400 may be considered a node operating with respect to the network 400.

As illustrated, the network 400 includes a plurality of edge OT nodes 404. In some embodiments, the edge OT nodes 404 includes one or more OT device(s) connected to the network. In some embodiments, the OT device(s) control and/or monitor one or more operation(s) of an industrial system. Additionally or alternatively, in some embodiments, the edge OT node(s) of the edge OT nodes 404 enable interfacing and/or interaction with a monitored and/or controlled environment automatically and/or in response to user input via the device(s) embodying such node(s). For example, in some embodiments, the edge OT nodes 404 includes one or more video and/or collaboration device(s), wireless vibration monitor(s), radar gauge(s), handheld device(s), user device(s), sensor(s), HART device(s), Experion mobile station(s), and/or the like. Additionally or alternatively, in some embodiments, the edge OT nodes 404 includes wireless and/or wired networking solution node(s), for example wireless LAN controller(s), traffic processing device(s), and/or industrial switch(es) that route traffic between particular nodes for transmission and/or further processing. In some embodiments, one or more of the edge OT nodes 404 is wirelessly connected to the network 400, such that message communication(s) transmitted to and/or from a particular node is performed via a wireless communication protocol (e.g., Wi-Fi, Zigbee, Bluetooth, and/or the like). Additionally or alternatively, in some embodiments, the edge OT nodes 404 includes one or more node(s) having a wired connection to the network 400 (e.g., over ethernet, and/or the like). In this regard, the network 400 including at least one wirelessly connected device (e.g., a wirelessly connected OT device) may embody a wireless OT network that facilitates wireless communication(s) with the wirelessly connected device.

The network 400 includes a plurality of nodes arranged in particular layers. In some embodiments, for example, the network 400 is arranged in layers based at least in part on the OSI model of network architecture(s). For example, as illustrated, the network 400 includes a plurality of nodes arranged into particular networking layers, for example L1 nodes 414, L2 nodes 412, L3 nodes 410, L3.5 nodes 408, and L4 nodes 406. In some embodiments, the layers are arranged in a manner that includes particular devices having particular functionality in accordance with the OSI model. For example, in some embodiments, the L1 nodes 414 includes controller(s) and/or physical monitoring devices that perform data collection and/or generation and/or associated switch(es) and/or firewall(s), L2 nodes 412 includes console station(s) and/or redundant server(s) (e.g., Experion servers) and/or associated switch(es) that perform addressing and/or media access, L3 nodes 410 includes at least one router and/or switch, domain controller with authentication server, application server(s) (e.g., Experion application server(s) and/or the like), field device management server(s), digital video management server(s), client(s), and/or the like that perform logical addressing and pathing of message communication(s) over the network 400, L3.5 nodes 408 that include a primary firewall (e.g., an 802.1x supporting firewall), security management server(s), antivirus management server(s), eServer(s), remote station and engineering server(s), shadow server(s), proxy server(s), and/or the like that embody a DMZ connection with an external and/or public network (e.g., the Internet), and L4 nodes 406 including a switch and business network, engineering client, eServer client, and/or the like that provide access to the functionality and/or data of lower-layer devices from external from a secured portion of the network 400. It will be appreciated that in other embodiments the network layers may be arranged in accordance with other categorizations of functionality. In one or more embodiments, the data diode computer system 302 can be implemented via the L3.5 nodes 408.

In some embodiments, the network 400 includes an OT network management system 402 deployed within the network. In some embodiments, the OT network management system 402 includes hardware, software, firmware, and/or any combination thereof, that performs functionality for managing initiation of an automated healing process for operational technology devices in a network as described herein. For example, in some embodiments, the OT network management system 402 includes one or more personal computer(s), application server(s), database server(s), enterprise terminal(s), and/or the like that is specially configured via one or more software application(s) to perform the functionality described herein. In some embodiments, the OT network management system 402 detects and/or otherwise identifies message communication(s) transmitted by and/or between node(s) of the network 400 for processing. Additionally or alternatively, in some embodiments, the OT network management system 402 processes data, for example identified message communication(s), stored data associated with the configuration of the network 400, and/or the like, to detect node(s) that are vulnerable to one or more cybersecurity risk(s), and/or that the network 400 is vulnerable to one or more cybersecurity risk(s). Additionally or alternatively, in some embodiments, the OT network management system 402 identifies at least one resolution for at least one cybersecurity risk, and/or initiates at least one simulation associated with implementation of at least one identified resolution, and/or generation of solution implementation report based at least in part on the at least one simulation. Additionally or alternatively, in some embodiments, the OT network management system 402 processes data to determine whether to automatically initiate at least one resolution to one or more identified cybersecurity risk(s), for example whether to automatically initiate at least one computer-executable resolution, and/or whether to cause rendering of at least one alert for manual review of data associated with an identified cybersecurity risk and/or identified computer-executable resolution.

In some embodiments, the OT network management system 402 is disposed within a particular layer of the network 400. For example, as illustrated, the OT network management system 402 is disposed within the L3 layer of the network 400, as one of the L3 nodes 410. In some embodiments, the OT network management system 402 is disposed in the L3 layer to enable capturing of wireless and wired message communication(s) transmitted via the network 400. In this regard, the OT network management system 402 may enable data-driven determinations associated with wirelessly connected OT devices and/or other node(s) of the network 400 wireless connected for communication via the network 400.

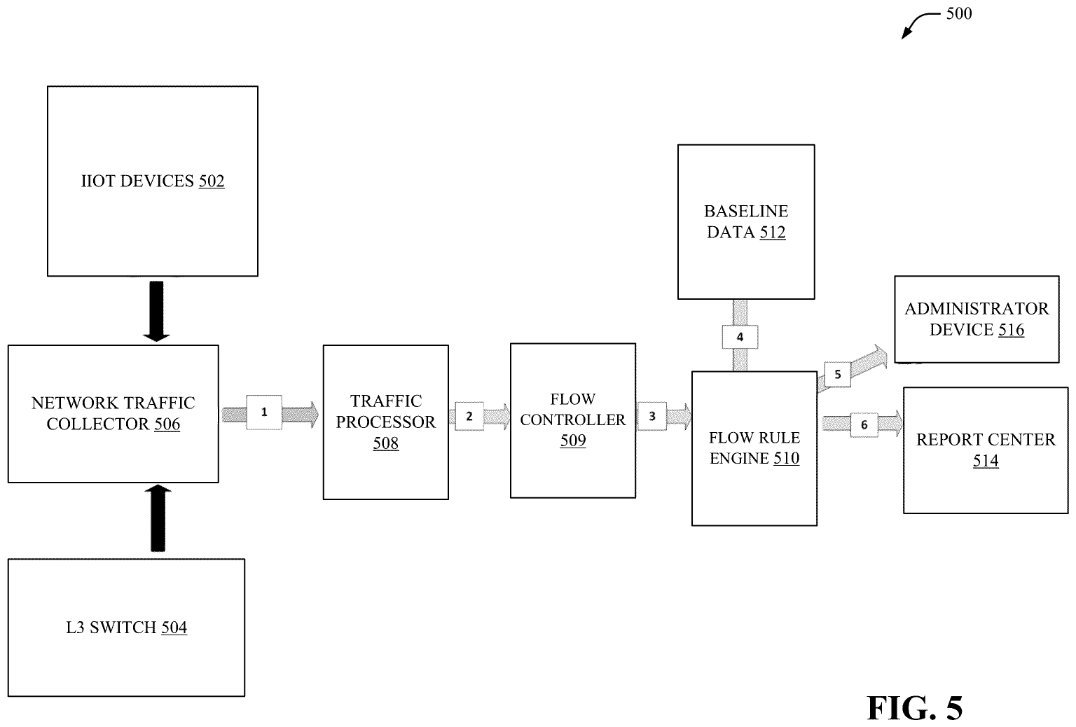

FIG. 5 illustrates an example visualization of operations performed for managing data packets for operational technology devices in a network in accordance with one or more embodiments of the present disclosure. In some embodiments, the operations embody a data flow between particular device(s) and/or sub-systems of a device for managing initiation of an automated healing process for operational technology devices in a network. For example, in some embodiments, the data flow occurs between IIOT devices 502, L3 switch 504, and administrator device 516 in communication with the data diode computer system 302 each disposed within a particular network (e.g., a wireless OT network). As illustrated, the network traffic collector 506, traffic processor 508, flow controller 509, flow rule engine 510, and report center 514 are embodied in whole or in part by sub-systems of the data diode computer system 302, for example embodied in hardware, software, firmware, and/or any combination thereof.

As illustrated, the IIOT devices 502 and L3 switch 504 interact with the network traffic collector 506. In some embodiments, the IIOT devices 502 includes one or more OT device(s) wirelessly connected to the network. In some embodiments, the network traffic collector 506 generates and/or otherwise extracts data packet(s) based at least in part on the operation of the IIOT devices 502 with the network. For example, in some embodiments, the network traffic collector 506 generates and/or otherwise collects data packet(s) based at least in part on data associated with the identity and/or configuration(s) IIOT devices 502. In one or more embodiments, the network traffic collector 506 collects the data packet 320. Alternatively or additionally, in some embodiments, the IIOT devices 502 generates and/or collects data packet(s) based at least in part on message communication(s) transmitted over a particular network, for example where the network includes the L3 switch 504. In some such embodiments, the message communication(s) may be captured and/or processed upon reaching the L3 switch 504, for example to enable capturing of message communication(s) transmitted over wireless means and/or wired means.

In some embodiments, the network traffic collector 506 (e.g., embodied as a subsystem of the data diode computer system 302) provides the generated and/or collected data packet(s) to the traffic processor 508. In some embodiments, the data packet(s) are in an unstandardized and/or unnormalized format that makes comparison, processing, and/or storing of the data packets impractical or impossible. In some such embodiments, the traffic processor 508 may normalize the data packet(s) into structured data packet(s) of a standardized format to enable such comparison, processing, and/or storing of the structured data packet(s). Additionally or alternatively, in some embodiments, the traffic processor 508 classifies the type of structured data packet(s) for comparison and/or monitoring with respect to the network, as described herein.

In some embodiments, the traffic processor 508 (e.g., embodied by a subsystem of data diode computer system 302 in hardware, software, firmware, and/or any combination thereof) processes the structured data packet(s) to determine one or more attributes associated with the data packet(s). In some embodiments, the traffic processor 508 includes any of a myriad of rule set(s), algorithm(s), machine learning model(s), artificial intelligence model(s), and/or the like that detect data attributes based at least in part on the structured data packet(s). In some embodiments, the traffic processor 508 provides the structured data packet(s) to the flow controller 509 and/or the flow rule engine 510 for processing. The flow controller 509 can manage unidirectional transmission of the data packet(s) (e.g., from OT to IT, from sensor(s) to controller, etc.) based on data comparison and/or validation associated with the flow rule engine 510. In some embodiments, the flow rule engine 510 processes the structured data packet(s) based at least in part on comparison with baseline data 512. For example, in some embodiments, the flow rule engine 510 compares the structured data packet(s) with the baseline data 512 to determine whether the one or more attributes of the structured data packet(s) match one or more flow rules associated with a flow table. In some embodiments, the flow rule engine 510 retrieves the baseline data 512 embodying the flow rule engine 510, and/or retrieves a set of flow rules, a model, and/or the like, utilized for processing the structured data packet(s) from at least one data repository that stores such data. In some embodiments, the flow rule engine 510 generates a report indicating the results of the processing of the data packet(s) by the flow rule engine 510. For example, in some embodiments, the report indicates results representing detected matches or other incident(s) detected based at least in part on the structured data packet(s).

In some embodiments, the flow rule engine 510 transmits the report to the report center 514. In some embodiments, the report center 514 (e.g., embodied by a subsystem of data diode computer system 302 in hardware, software, firmware, and/or any combination thereof) stores the report. Additionally or alternatively, in some embodiments, the report center 514 causes generation of at least one alert based at least in part on a detected match or other incident represented in the report. For example, in some embodiments, the report center 514 causes generation of at least one alert at an administrator device 516, such that an administrator associated with the administrator device 516 may view a user interface including or based at least in part on the alert to review the alert and/or initiate a desired resolution. Additionally or alternatively, in some embodiments, the report center 514 initiates or causes updating of a network list and/or generation of a new network for a network list in a circumstance where the report satisfies one or more defined matching criterion/criteria, as described herein.

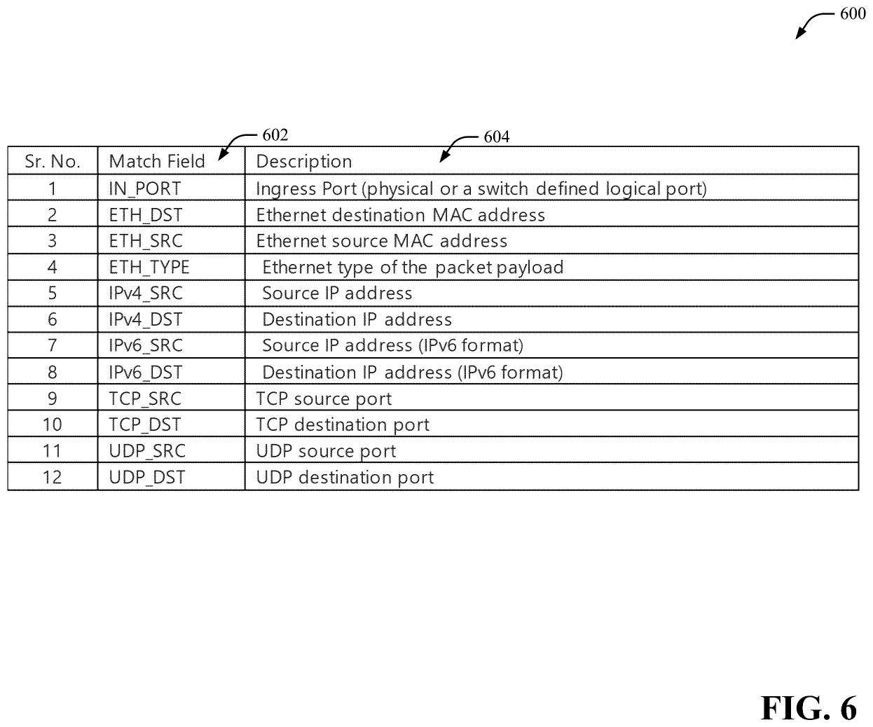

FIG. 6 illustrates an example flow table 600 in accordance with one or more embodiments of the present disclosure. For example, the flow table 600 can correspond to a flow table from the one or more flow tables 318. The flow table 600 can include a set of match fields 602 and corresponding descriptions 604 for respective match fields. For example, the set of match fields 602 can include match fields ranging from Layer1 to Layer4 to provide fine-grained control over identification of a data packet and/or transmission of a data packet based on the corresponding descriptions 604.

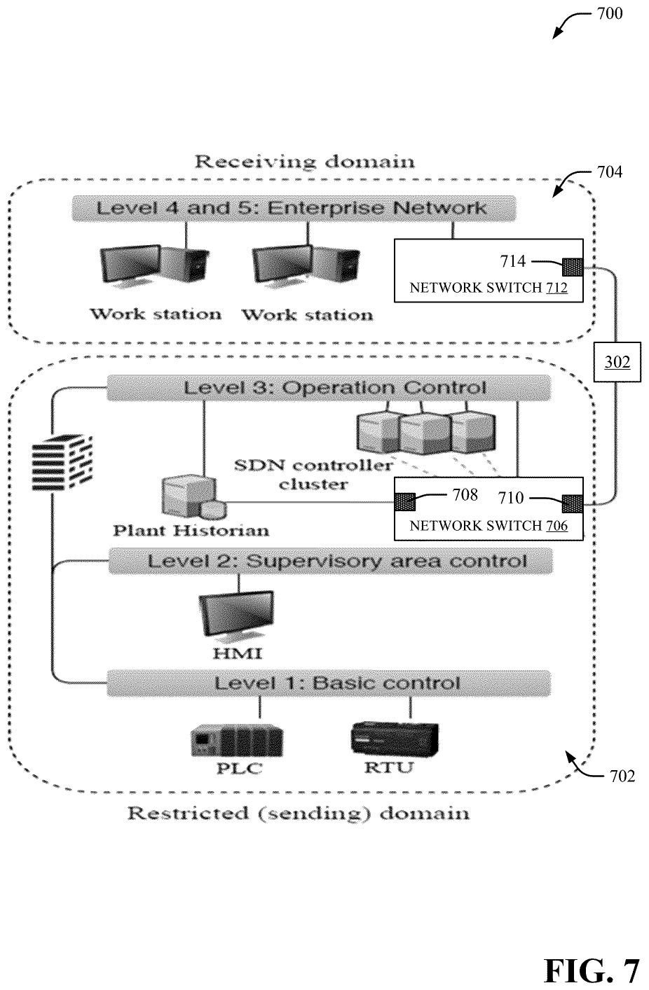

FIG. 7 illustrates an example system 700 in accordance with one or more embodiments of the present disclosure. The system 700 includes a first network 702 and a second network 704. The first network 702 and the second network 704 can be distinct networks. In one or more embodiments, the first network 702 can be, for example, a restricted domain (e.g., a sending domain) that generates and/or provides a data packet (e.g., the data packet 320) received by the data diode computer system 302. The second network 704 can be, for example, a receiving domain that receives a data packet (e.g., the data packet 320) associated with the first network based on unidirectional control of the data packet via the data diode computer system 302. In one or more embodiments, the data diode computer system 302 can be implemented between the first network 702 and the second network 704.

In one or more embodiments, the data diode computer system 302 is configured as a proactive data diode. For example, the data diode computer system 302 can be configured as an SDN unidirectional gateway that utilizes one or more proactive flow rules. To facilitate unidirectional communication between the first network 702 and the second network 704 illustrated in FIG. 7, the data diode computer system 302 can utilize a communication protocol such as a UDP protocol or another type of communication protocol. The one or more proactive flow rules can correspond to at least a portion of the set of flow rules utilized by the flow table component 306 to analyze one or more attributes of a data packet (e.g., the data packet 320) provided by the first network 702. In one or more embodiments, the first network 702 includes a network switch 706. The network switch 706 can store one or more flow tables such as, for example, the one or more flow tables 318. Additionally, the one or more flow tables stored by the network switch 706 can store a set of flow rules for the one or more flow tables. The set of flow rules stored by the network switch 706 can include the one or more proactive flow rules. In one or more embodiments, the network switch 706 can receive a data packet (e.g., the data packet 320) via a switch port 710 of the network switch 706. In certain embodiments, the network switch 706 can be a domain uplink switch.

An example proactive flow rule can instruct the network switch 706 to drop a data packet originating from a network switch 712 included in the second network 704. Another example proactive flow rule can instruct the network switch 706 to analyze a data packet originating from within the first network 702. Another example proactive flow rule can instruct the network switch 706 to forward a data packet originating from within the first network 702 to the second network 704 based at least in part on a device identifier for a device in the second network 704 and/or match field information included in a flow table such as, but not limited to, defined switch port information for a data packet destination, defined ethernet type information for a data packet destination, defined IP address information for a data packet destination, etc. For example, the data diode computer system 302 can configure the network switch 706 to transmit a data packet via a defined switch port of the second network 704 (e.g., a switch port 714 of the network switch 712) in response to a determination that the one or more attributes of the data packet matches at least one proactive flow rule for the network switch 706. To support TCP applications, in certain embodiments the network switch 706 can encapsulate a data packet into an UDP packet. Alternatively, the one or more proactive flow rule can be configured to set the UDP source and destination ports, and replace the TCP source and destination fields, to any TCP data packets entering the network switch 706.

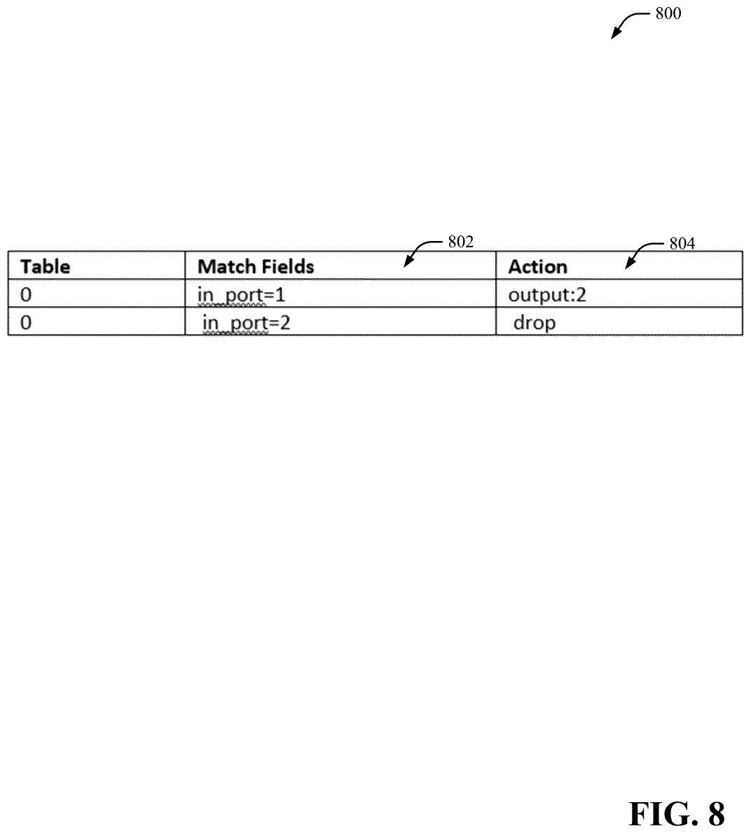

FIG. 8 illustrates an example flow table 800 in accordance with one or more embodiments of the present disclosure. For example, the flow table 800 can correspond to a flow table from the one or more flow tables 318. In one or more embodiments, the flow table 800 can be associated with the network switch 706. The flow table 800 can include a set of match fields 802 and corresponding actions 804 for respective match fields. For example, the set of match fields 802 can be related to proactive flow rules such as a defined switch port information for performing certain actions such as transmitting and/or receiving a data packet, dropping a data packet, etc.

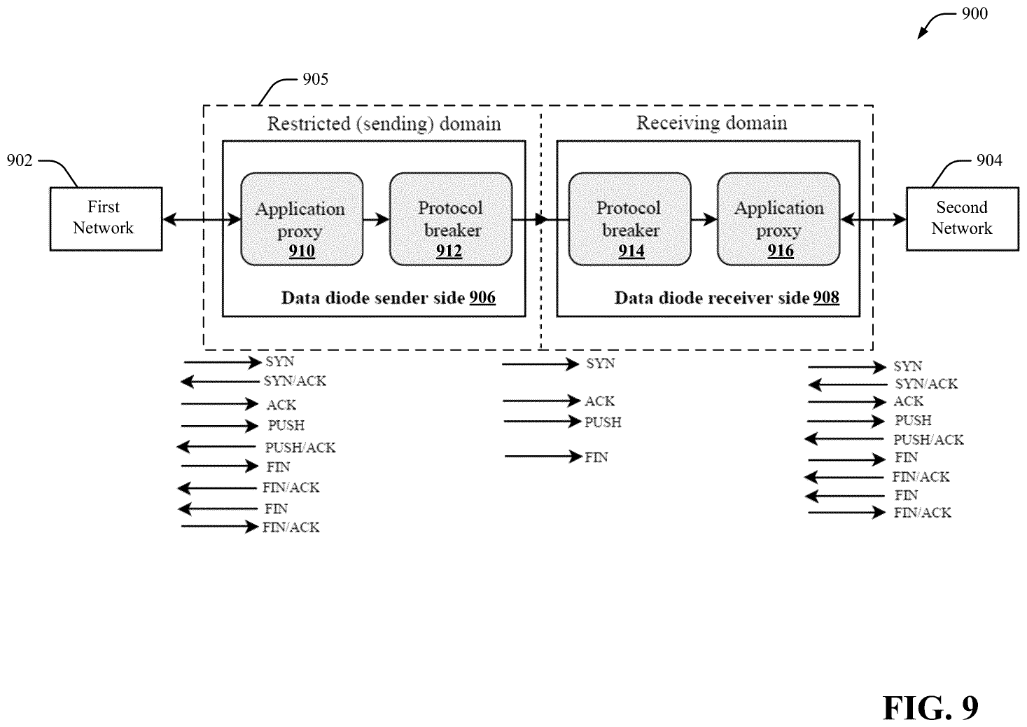

FIG. 9 illustrates an example system 900 in accordance with one or more embodiments of the present disclosure. The system 900 includes a first network 902 and a second network 904. The first network 902 and the second network 904 can be distinct networks. For example, the first network 902 can be a TCP client and the second network 904 can be a TCP server. In various embodiments, the first network 902 can be a restricted domain (e.g., a sending domain) that generates and/or provides a data packet (e.g., the data packet 320) received by the data diode computer system 302. The second network 904 can be, for example, a receiving domain that receives a data packet (e.g., the data packet 320) associated with the first network based on unidirectional control of the data packet via the data diode computer system 302. In one or more embodiments, a data diode 905 can be implemented between the first network 902 and the second network 904. In one or more embodiments, the data diode computer system 302 can correspond to or be included in the data diode 905. In an embodiment, the data diode 905 can be configured as a reactive data diode. The data diode 905 can include a data diode sender side 906 associated with the first network 902 and a data diode receiver side 908 associated with the second network 904. The data diode sender side 906 can include an application proxy 910 and/or a protocol breaker 912. The data diode receiver side 908 can include a protocol breaker 914 and/or an application proxy 916. Data packets can be transmitted via a unidirectional communication path from the data diode sender side 906 and to the data diode receiver side 908.

In one or more embodiments, the data diode sender side 906 can be configured as a first network controller and the data diode receiver side 908 can be configured as a second network controller. A data packet can be forwarded to the data diode sender side 906 (e.g., a network controller of the first network 902) in response to a determination that one or more attributes of the data packet match at least one reactive flow rule. For example, the reactive flow rule can instruct a network switch to forward any received data packet (e.g., as identified by a data packet header of the data packet) to the data diode sender side 906 for further processing. The data diode sender side 906 can determine whether the received data packet comes from the receiving domain (e.g., by identifying an input port associated with the data packet) and can instruct a network switch to drop the data packet in response to a determination that the data packet is received via a defined switch port. Similarly, the data diode sender side 906 can instruct a network switch to forward a data packet if the data packet originates from the first network 902.

Using a reactive approach, the data diode sender side 906 support various communication protocols such as, for example, a TCP protocol. The data diode sender side 906 can also behave as an application proxy for TCP connections. For example, TCP acknowledge packets can be faked by the data diode sender side 906 and outputted via a switch port to the second network 904 establishing the connection. Hence, a TCP protocol can be supported while enabling unidirectional communications. Furthermore, in certain embodiments, the data diode 905 can be configured for bi-directional communication between the first network 902 and the second network 904 (e.g., to provide an application that relies on TCP for initial connection establishment between the first network 902 and the second network 904). Accordingly, the data diode 905 can be programmed in such a way that bi-directional communication is enabled in certain embodiments to emulate a reversible data diode.

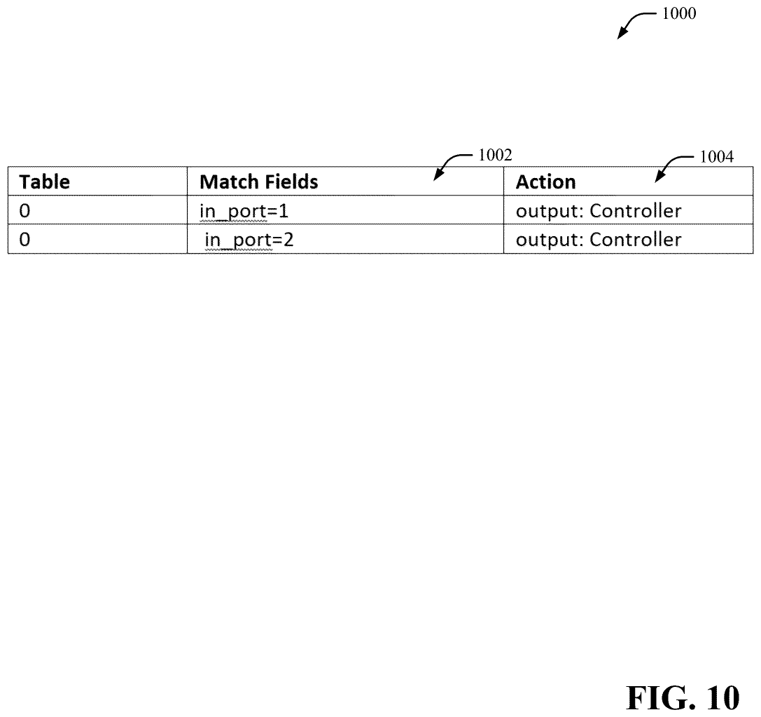

FIG. 10 illustrates an example flow table 1000 in accordance with one or more embodiments of the present disclosure. For example, the flow table 1000 can correspond to a flow table from the one or more flow tables 318. In one or more embodiments, the flow table 1000 can be associated with the data diode 905. The flow table 1000 can include a set of match fields 1002 and corresponding actions 1004 for respective match fields. For example, the set of match fields 1002 can be related to reactive flow rules such as a defined switch port information for performing certain actions for forwarding a data packet to a network controller for further processing.

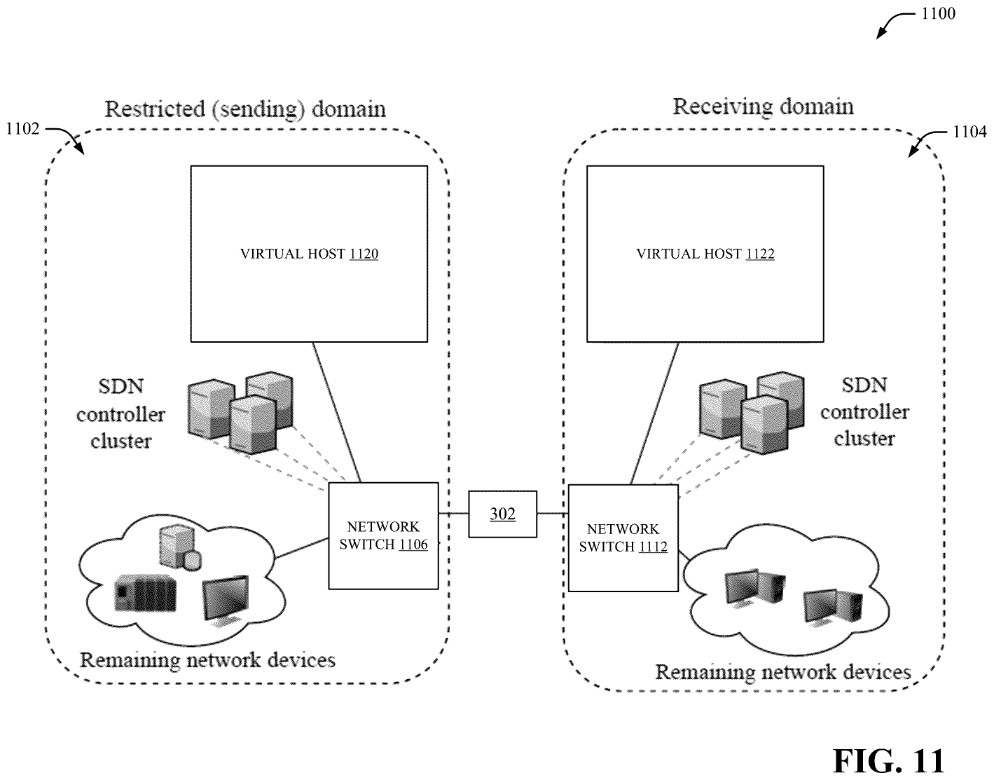

FIG. 11 illustrates an example system 1100 in accordance with one or more embodiments of the present disclosure. The system 1100 includes a first network 1102 and a second network 1104. The first network 1102 and the second network 1104 can be distinct networks. In one or more embodiments, the first network 1102 can be, for example, a restricted domain (e.g., a sending domain) that generates and/or provides a data packet (e.g., the data packet 320) received by the data diode computer system 302. The second network 1104 can be, for example, a receiving domain that receives a data packet (e.g., the data packet 320) associated with the first network based on unidirectional control of the data packet via the data diode computer system 302. In one or more embodiments, the data diode computer system 302 can be implemented between the first network 1102 and the second network 1104.

In one or more embodiments, the data diode computer system 302 can forward a data packet to a virtual host 1120 of the first network 1102 and/or a virtual host 1122 of the second network 1104 in response to a determination that one or more attributes of the data packet match at least one NFV flow rule. For example, a data packet originating in the first network 1102 with the second network 1104 as a destination for the data packet can be offloaded by the network switch 1106 to the virtual host 1120 of the first network 1102 and/or the virtual host 1122 of the second network 1104. The virtual host 1120 and/or the virtual host 1122 can be, for example, a hypervisor configured as a virtual switch. For example, the virtual host 1120 and/or the virtual host 1122 can be a virtual machine or an application container with two virtual Ethernet interfaces (e.g., a first Ethernet interface for receiving data packets and a second Ethernet interface for outputting data packets).

In various embodiments, the virtual host 1120 and/or the virtual host 1122 can perform TCP emulation by automatically generating acknowledgment packets for data handshakes and/or subsequent TCP transfers. Data packets that are destined for a particular network can be chained from an input virtual interface to an output virtual interface using, for example, IP flow tables configured with data packet filter rules. An example NFV flow rule can instruct the network switch 1106 to drop any data packets coming from the second network 1104. Another example NFV flow rule can instruct the network switch 1106 to forward any data packets from the virtual host 1120 to a defined switch port of a network switch 1112 included in the second network 1104. Another example NFV flow rule can instruct the network switch 1106 to forward certain data packets to the virtual host 1120 and/or the virtual host 1122. Accordingly, the data diode computer system 302 can mitigate flooding attacks against the first network 1102 and/or the second network 1104 while maintaining data communication flexibility for a network.

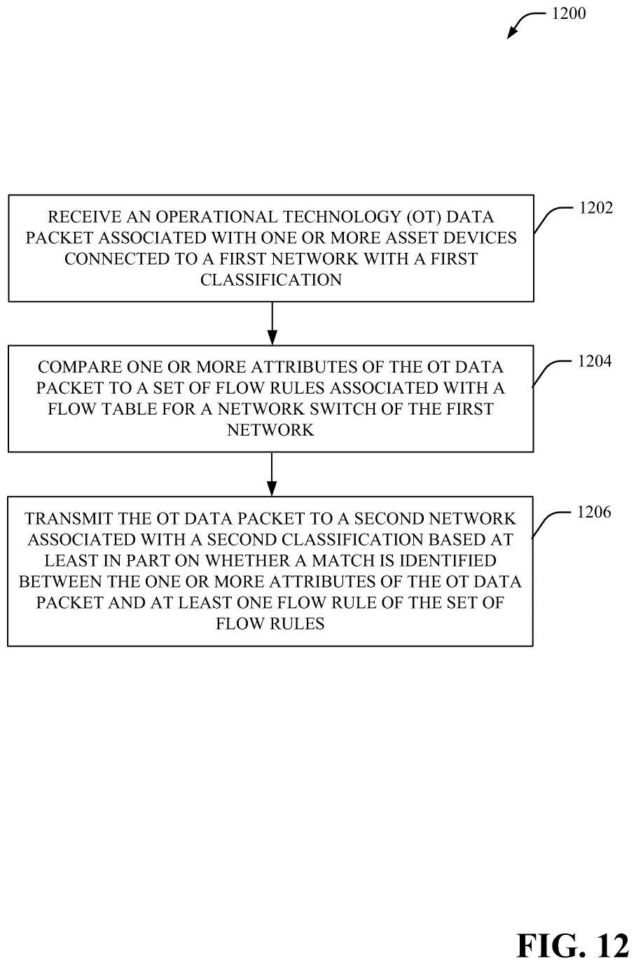

FIG. 12 illustrates a method 1200 for providing unidirectional communication of data via a data diode between distinct networks, in accordance with one or more embodiments described herein. The method 1200 is associated with the data diode computer system 302, for example. For instance, in one or more embodiments, the method 1200 is executed at a device (e.g., the data diode computer system 302) with one or more processors and a memory. In one or more embodiments, the method 1200 begins at block 1202 that receives (e.g., by the data packet component 304) an operational technology (OT) data packet associated with one or more asset devices connected to a first network with a first classification. In one or more embodiments, the OT data packet is received via data diode configured for SDN. The method additionally includes a block 1204 that compares (e.g., by the flow table component 306) one or more attributes of the OT data packet to a set of flow rules associated with a flow table for a network switch of the first network. The method additionally includes a block 1206 that transmits (e.g., by the action component 308) the OT data packet to a second network associated with a second classification based at least in part on whether a match is identified between the one or more attributes of the OT data packet and at least one flow rule of the set of flow rules. In one or more embodiments, the first network is an OT network and the second network is an IT network.

In one or more embodiments, the method 1200 additionally or alternatively includes applying an instruction set for the OT data packet to cause transmission of the OT data packet to the second network in response to a determination that the one or more attributes of the OT data packet match at least one flow rule of the set of flow rules. The instruction set can be configured via the flow table.

In one or more embodiments, the method 1200 additionally or alternatively includes transmitting the OT data packet via a defined switch port of the second network in response to a determination that the one or more attributes of the OT data packet match at least one proactive flow rule of the set of flow rules.

In one or more embodiments, the method 1200 additionally or alternatively includes forwarding the OT data packet to a network controller of the first network in response to a determination that the one or more attributes of the OT data packet match at least one reactive flow rule of the set of flow rules.

In one or more embodiments, the method 1200 additionally or alternatively includes forwarding the OT data packet to a virtual host of the second network in response to a determination that the one or more attributes of the OT data packet match at least one network function virtualization (NFV) flow rule of the set of flow rules.

In one or more embodiments, the method 1200 additionally or alternatively includes modifying one or more portions of a data packet header of the OT data packet in response to a determination that the one or more attributes of the OT data packet do not match at least one flow rule of the set of flow rules.

In one or more embodiments, the method 1200 additionally or alternatively includes decoupling network equipment functionality between the first network and the second network in response to a determination that the one or more attributes of the OT data packet do not match at least one flow rule of the set of flow rules.

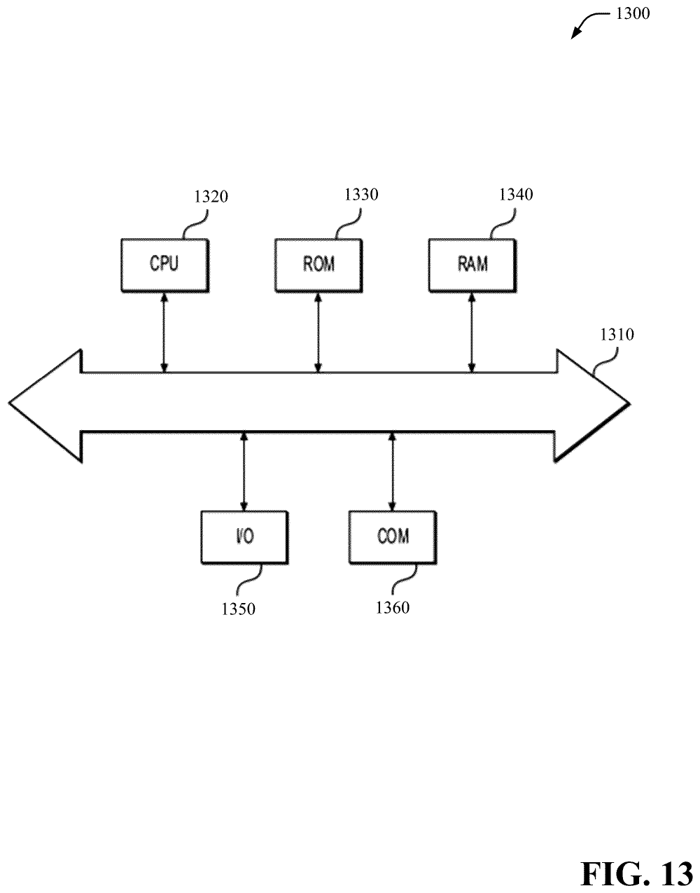

FIG. 13 depicts an example system 1300 that may execute techniques presented herein. FIG. 13 is a simplified functional block diagram of a computer that may be configured to execute techniques described herein, according to exemplary embodiments of the present disclosure. Specifically, the computer (or “platform” as it may not be a single physical computer infrastructure) may include a data communication interface 1360 for packet data communication. The platform also may include a central processing unit (“CPU”) 1320, in the form of one or more processors, for executing program instructions. The platform may include an internal communication bus 1310, and the platform also may include a program storage and/or a data storage for various data files to be processed and/or communicated by the platform such as ROM 1330 and RAM 1340, although the system 1300 may receive programming and data via network communications. The system 1300 also may include input and output ports 1350 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments can be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

It is to be appreciated that ‘one or more’ includes a function being performed by one element, a function being performed by more than one element, e.g., in a distributed fashion, several functions being performed by one element, several functions being performed by several elements, or any combination of the above.

Moreover, it will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems or methods unless specifically designated as mandatory. For case of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

The hardware used to implement the various illustrative logics, logical blocks, modules, and circuits described in connection with the aspects disclosed herein can include a general purpose processor, a digital signal processor (DSP), a special-purpose processor such as an application specific integrated circuit (ASIC) or a field programmable gate array (FPGA), a programmable logic device, discrete gate or transistor logic, discrete hardware components, or any combination thereof designed to perform the functions described herein. A general-purpose processor can be a microprocessor, but, in the alternative, the processor can be any processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Alternatively, or in addition, some steps or methods can be performed by circuitry that is specific to a given function.

In one or more example embodiments, the functions described herein can be implemented by special-purpose hardware or a combination of hardware programmed by firmware or other software. In implementations relying on firmware or other software, the functions can be performed as a result of execution of one or more instructions stored on one or more non-transitory computer-readable media and/or one or more non-transitory processor-readable media. These instructions can be embodied by one or more processor-executable software modules that reside on the one or more non-transitory computer-readable or processor-readable storage media. Non-transitory computer-readable or processor-readable storage media can in this regard comprise any storage media that can be accessed by a computer or a processor. By way of example but not limitation, such non-transitory computer-readable or processor-readable media can include random access memory (RAM), read-only memory (ROM), electrically erasable programmable read-only memory (EEPROM), FLASH memory, disk storage, magnetic storage devices, or the like. Disk storage, as used herein, includes compact disc (CD), laser disc, optical disc, digital versatile disc (DVD), floppy disk, and Blu-ray Disc™, or other storage devices that store data magnetically or optically with lasers. Combinations of the above types of media are also included within the scope of the terms non-transitory computer-readable and processor-readable media. Additionally, any combination of instructions stored on the one or more non-transitory processor-readable or computer-readable media can be referred to herein as a computer program product.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components can be used in conjunction with the supply management system. Therefore, it is to be understood that the inventions are not to be limited to the specific embodiments disclosed and that modifications and other embodiments are intended to be included within the scope of the appended claims. Moreover, the steps in the method described above can not necessarily occur in the order depicted in the accompanying diagrams, and in some cases one or more of the steps depicted can occur substantially simultaneously, or additional steps can be involved. Although specific terms are employed herein, they are used in a generic and descriptive sense only and not for purposes of limitation.

It is intended that the specification and examples be considered as exemplary only, with a true scope and spirit of the disclosure being indicated by the following claims.

What is claimed is:

1. A data diode system, comprising:
one or more processors;
a memory; and
one or more programs stored in the memory, the one or more programs comprising instructions configured to:
receive an operational technology (OT) data packet associated with one or more asset devices connected to a first network with a first classification;
compare one or more attributes of the OT data packet to a set of flow rules associated with a flow table for a network switch of the first network; and
transmit the OT data packet to a second network associated with a second classification based at least in part on whether a match is identified between the one or more attributes of the OT data packet and at least one flow rule of the set of flow rules.

2. The data diode system of claim 1, wherein the first network is an OT network and the second network is an information technology (IT) network.

3. The data diode system of claim 1, wherein the OT data packet is received via a data diode configured for software defined networking (SDN).

4. The data diode system of claim 1, the one or more programs further comprising instructions configured to:
apply an instruction set for the OT data packet to cause transmission of the OT data packet to the second network in response to a determination that the one or more attributes of the OT data packet match at least one flow rule of the set of flow rules,
wherein the instruction set is configured via the flow table.

5. The data diode system of claim 1, the one or more programs further comprising instructions configured to:
transmit the OT data packet via a defined switch port of the second network in response to a determination that the one or more attributes of the OT data packet match at least one proactive flow rule of the set of flow rules.

6. The data diode system of claim 1, the one or more programs further comprising instructions configured to:
forward the OT data packet to a network controller of the first network in response to a determination that the one or more attributes of the OT data packet match at least one reactive flow rule of the set of flow rules.

7. The data diode system of claim 1, the one or more programs further comprising instructions configured to:
forward the OT data packet to a virtual host of the second network in response to a determination that the one or more attributes of the OT data packet match at least one network function virtualization (NFV) flow rule of the set of flow rules.

8. The data diode system of claim 1, the one or more programs further comprising instructions configured to:
modify one or more portions of a data packet header of the OT data packet in response to a determination that the one or more attributes of the OT data packet do not match at least one flow rule of the set of flow rules.

9. The data diode system of claim 1, the one or more programs further comprising instructions configured to:
decouple network equipment functionality between the first network and the second network in response to a determination that the one or more attributes of the OT data packet do not match at least one flow rule of the set of flow rules.

10. A computer-implemented method comprising:
receiving an operational technology (OT) data packet associated with one or more asset devices connected to a first network with a first classification;
comparing one or more attributes of the OT data packet to a set of flow rules associated with a flow table for a network switch of the first network; and
transmitting the OT data packet to a second network associated with a second classification based at least in part on whether a match is identified between the one or more attributes of the OT data packet and at least one flow rule of the set of flow rules.

11. The computer-implemented method of claim 10, wherein the receiving the OT data packet comprises receiving the OT data packet via a data diode configured for software defined networking (SDN).

12. The computer-implemented method of claim 10, further comprising:
applying an instruction set for the OT data packet to cause transmission of the OT data packet to the second network in response to a determination that the one or more attributes of the OT data packet match at least one flow rule of the set of flow rules,
wherein the instruction set is configured via the flow table.

13. The computer-implemented method of claim 10, wherein the transmitting the OT data packet comprises transmitting the OT data packet via a defined switch port of the second network in response to a determination that the one or more attributes of the OT data packet match at least one proactive flow rule of the set of flow rules.

14. The computer-implemented method of claim 10, wherein the transmitting the OT data packet comprises forwarding the OT data packet to a network controller of the first network in response to a determination that the one or more attributes of the OT data packet match at least one reactive flow rule of the set of flow rules.

15. The computer-implemented method of claim 10, wherein the transmitting the OT data packet comprises forwarding the OT data packet to a virtual host of the second network in response to a determination that the one or more attributes of the OT data packet match at least one network function virtualization (NFV) flow rule of the set of flow rules.

16. The computer-implemented method of claim 10, further comprising:
modifying one or more portions of a data packet header of the OT data packet in response to a determination that the one or more attributes of the OT data packet do not match at least one flow rule of the set of flow rules.

17. The computer-implemented method of claim 10, further comprising:
decoupling network equipment functionality between the first network and the second network in response to a determination that the one or more attributes of the OT data packet do not match at least one flow rule of the set of flow rules.

18. A computer program product comprising at least one non-transitory computer-readable storage medium having computer-readable program code portions stored therein, the computer-readable program code portions comprising an executable portion configured to:
receive an operational technology (OT) data packet associated with one or more asset devices connected to a first network with a first classification;
compare one or more attributes of the OT data packet to a set of flow rules associated with a flow table for a network switch of the first network; and
transmit the OT data packet to a second network associated with a second classification based at least in part on whether a match is identified between the one or more attributes of the OT data packet and at least one flow rule of the set of flow rules.

19. The computer program product of claim 18, the computer-readable program code portions further comprising an executable portion configured to:
forward the OT data packet to a network controller of the first network in response to a determination that the one or more attributes of the OT data packet match at least one reactive flow rule of the set of flow rules.

20. The computer program product of claim 18, the computer-readable program code portions further comprising an executable portion configured to:
forward the OT data packet to a virtual host of the second network in response to a determination that the one or more attributes of the OT data packet match at least one network function virtualization (NFV) flow rule of the set of flow rules.
